(19) United States
(12) Patent Application Publication
(10) Pub. No.: US 2024/0056150 A1
(43) Pub. Date: Feb. 15, 2024

(54) SEMI-PERSISTENT CHANNEL STATE INFORMATION REFERENCE SIGNAL ACTIVATION IN A DIRECT SECONDARY CELL ACTIVATION

(71) Applicant: QUALCOMM Incorporated, San Diego, CA (US)

(72) Inventors: Fang YUAN, Beijing (CN); Yan ZHOU, San Diego, CA (US); Kazuki TAKEDA, Minato-ku (JP); Tao LUO, San Diego, CA (US)

(21) Appl. No.: 18/264,716

(22) PCT Filed: Apr. 14, 2021
(86) PCT No.: PCT/CN2021/087132

§ 371 Date: Aug. 8, 2023

(51) Int. Cl. H04B 7/06; H04W 16/28; H04W 76/20

(52) U.S. Cl. CPC H04B 7/0626; H04W 16/28; H04B 7/06968; H04W 76/20

(57) ABSTRACT

Various aspects of the present disclosure generally relate to wireless communication. In some aspects, a user equipment (UE) may receive a secondary cell activation command that indicates a semi-persistent channel state information (CSI) reference signal (CSI-RS) resource set of a secondary cell. The UE may receive, from the secondary cell, a semi-persistent CSI-RS using the semi-persistent CSI-RS resource set based at least in part on receiving the secondary cell activation command. Numerous other aspects are provided.

### FIELD OF THE DISCLOSURE

Aspects of the present disclosure generally relate to wireless communication and specifically, to techniques and apparatuses for semi-persistent channel state information (CSI) reference signal (CSI-RS) activation in a direct secondary cell (SCell) activation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different user equipments (UEs) to communicate on a municipal, national, regional, and even global level. New Radio (NR), which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM or SC-FDMA (for example, also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements are applicable to other multiple access technologies and the telecommunication standards that employ these technologies.

In some cases, a UE may use dual connectivity to connect to multiple cells at once. For example, the UE may select a set of candidate cells, and may select one or more primary cells (PCells), secondary cells (SCells), primary secondary cells (PSCells), or secondary primary cells or special cells (SPCells). The PCell and SCell may be referred to as serving cells. An SCell may be a cell, operating on a secondary frequency, which may be configured once a radio resource control (RRC) connection is established (for example, with a PCell) and which may be used to provide additional radio resources for the UE. An SCell may be an SCell in a standalone carrier aggregation configuration or an SCell in a dual connectivity mode, such as an Evolved Universal Mobile Telecommunications System Terrestrial Radio Access (E-UTRA)-NR dual connectivity (ENDC) mode, an NR-E-UTRA dual connectivity (NEDC) mode, an NR dual connectivity (NRDC) mode, or another dual connectivity mode. An SCell can be switched between an activated state and a deactivated state. To activate an SCell, a base station may transmit, to a UE, an SCell activation command. In some cases, to activate an SCell, channel state information (CSI) may be needed by the base station (for example, for CSI acquisition for a channel between the UE and the SCell to be activated). Additionally or alternatively, a transmission configuration indicator (TCI) state associated with the SCell may be needed to activate an SCell. As a result, multiple messages may be needed to complete an activation of an SCell (for example, to complete a transition of an SCell to an activated state). For example, separate, or independent, messages may be needed to indicate the SCell activation command, to indicate a CSI reporting configuration associated with the SCell, and to indicate a TCI state associated with the SCell. The multiple messages may introduce latency associated with activating an SCell because each message may introduce a delay (for example, a processing delay) associated with receiving and processing the message. Therefore, SCell activation may introduce latency and higher-layer overhead for operations associated with dual connectivity.

### SUMMARY

In some aspects, a user equipment (UE) for wireless communication includes at least one processor and at least one memory communicatively coupled with the at least one processor and storing processor-readable code that, when executed by the at least one processor, is configured to cause the UE to receive a secondary cell activation command that indicates a semi-persistent channel state information (CSI) reference signal (CSI-RS) resource set of a secondary cell. In some aspects, the processor-readable code, when executed by the at least one processor, is configured to cause the UE to receive, from the secondary cell, a semi-persistent CSI-RS using the semi-persistent CSI-RS resource set based at least in part on receiving the secondary cell activation command.

In some aspects, a base station for wireless communication includes at least one processor and at least one memory communicatively coupled with the at least one processor and storing processor-readable code that, when executed by the at least one processor, is configured to cause the base station to transmit a secondary cell activation command that indicates a semi-persistent CSI-RS resource set of a secondary cell associated with the base station. In some aspects, the processor-readable code, when executed by the at least one processor, is configured to cause the base station to transmit, to a UE, a semi-persistent CSI-RS using the semi-persistent CSI-RS resource set based at least in part on transmitting the secondary cell activation command.

Some aspects described herein provide a method of wireless communication performed by a UE. The method may include receiving a secondary cell activation command that indicates a semi-persistent CSI-RS resource set of a secondary cell. The method may include receiving, from the secondary cell, a semi-persistent CSI-RS using the semi-persistent CSI-RS resource set based at least in part on receiving the secondary cell activation command.

Some aspects described herein provide a method of wireless communication performed by a base station. The method may include transmitting a secondary cell activation command that indicates a semi-persistent CSI-RS resource set of a secondary cell associated with the base station. The method may include transmitting, to a user equipment (UE), a semi-persistent CSI-RS using the semi-persistent CSI-RS resource set based at least in part on transmitting the secondary cell activation command.

In some aspects, a non-transitory computer-readable medium storing a set of instructions for wireless communication includes one or more instructions that, when executed by one or more processors of a UE, cause the UE to receive a secondary cell activation command that indicates a semi-persistent CSI-RS resource set of a secondary cell. In some aspects, the one or more instructions, when executed by one or more processors of the UE, cause the UE to receive, from the secondary cell, a semi-persistent CSI-RS using the semi-persistent CSI-RS resource set based at least in part on receiving the secondary cell activation command.

In some aspects, a non-transitory computer-readable medium storing a set of instructions for wireless communication includes one or more instructions that, when executed by one or more processors of a base station, cause the base station to transmit a secondary cell activation command that indicates a semi-persistent CSI-RS resource set of a secondary cell associated with the base station. In some aspects, the one or more instructions, when executed by one or more processors of the base station, cause the base station to transmit, to a UE, a semi-persistent CSI-RS using the semi-persistent CSI-RS resource set based at least in part on transmitting the secondary cell activation command.

Some aspects described herein provide an apparatus for wireless communication. The apparatus may include means for receiving a secondary cell activation command that indicates a semi-persistent CSI-RS resource set of a secondary cell. The apparatus may include means for receiving, from the secondary cell, a semi-persistent CSI-RS using the semi-persistent CSI-RS resource set based at least in part on receiving the secondary cell activation command.

Some aspects described herein provide an apparatus for wireless communication. The apparatus may include means for transmitting a secondary cell activation command that indicates a semi-persistent CSI-RS resource set of a secondary cell associated with the apparatus. The apparatus may include means for transmitting, to a UE, a semi-persistent CSI-RS using the semi-persistent CSI-RS resource set based at least in part on transmitting the secondary cell activation command.

Aspects generally include a method, apparatus, system, computer program product, non-transitory computer-readable medium, user equipment, base station, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example base station (BS) in communication with a user equipment (UE) in a wireless network in accordance with the present disclosure.

FIG. 3 is a diagram illustrating an example of physical channels and reference signals in a wireless network, in accordance with the present disclosure.

FIG. 4 is a diagram illustrating an example of using beams for communications between a base station and a UE, in accordance with the present disclosure.

FIG. 5 is a diagram illustrating examples of carrier aggregation, in accordance with the present disclosure.

FIG. 6 is a diagram illustrating an example associated with a secondary cell (SCell) activation procedure, in accordance with the present disclosure.

FIG. 7 is a diagram illustrating an example associated with semi-persistent channel state information (CSI) reference signal (CSI-RS) activation in a direct SCell activation, in accordance with the present disclosure.

FIG. 8 is a flowchart illustrating an example process performed, for example, by a UE that supports semi-persistent CSI-RS activation in a direct SCell activation, in accordance with the present disclosure.

FIG. 9 is a flowchart illustrating an example process performed, for example, by a base station that supports semi-persistent CSI-RS activation in a direct SCell activation, in accordance with the present disclosure.

FIGS. 10 and 11 are block diagrams of example apparatuses for wireless communication in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to activating a semi-persistent channel state information (CSI) reference signal (CSI-RS) resource set with a direct secondary cell (SCell) activation. A direct SCell activation may refer to an SCell activation command that indicates information such that a separate message is not need to activate a transmission configuration indicator (TCI) state for the SCell to be activated. Some aspects more specifically relate to an SCell activation command (for example, a direct SCell activation command) that is transmitted by a cell, such as a PCell or an activated SCell, indicating a semi-persistent CSI-RS resource set of a SCell to be activated. In some aspects, the SCell activation command may indicate a TCI state of the SCell to be activated, or a CSI reporting configuration for the SCell to be activated. In some aspects, the SCell activation command may trigger, or otherwise cause, a transmission of a semi-persistent CSI-RS by the SCell to be activated (for example, using the semi-persistent CSI-RS resource set indicated by, or with, the SCell activation command). In some aspects, a UE may receive the semi-persistent CSI-RS and report a measurement of the semi-persistent CSI-RS to the SCell to be activated in a CSI report (for example, based at least in part on the CSI reporting configuration). In some aspects, the UE or the SCell may use the semi-persistent CSI-RS as a source reference signal for a TCI state of the SCell (for example, a TCI state indicated by, or with, the SCell activation command). For example, the UE or the SCell may obtain quasi-colocation (QCL) information for a downlink channel or may obtain a spatial transmit filter parameter for an uplink channel based at least in part on the semi-persistent CSI-RS. In some aspects, the TCI state for the SCell may be a unified TCI state (for example, a TCI state that indicates information for one or more channels).

Particular aspects of the subject matter described in this disclosure can be implemented to realize one or more of the following potential advantages. In some examples, the described techniques can be used to reduce latency associated with activating an SCell. For example, using the direct SCell activation with the semi-persistent CSI-RS activation may enable a TCI state to be activated for the SCell, a source reference signal for the TCI state to be indicated, and for a CSI report to be activated without the transmission of multiple, separate, messages (for example, without the transmission of multiple medium access control (MAC) control elements (MAC-CEs) or downlink control information (DCI) messages). This reduces latency that would otherwise be associated with processing the multiple messages (for example, with processing multiple MAC-CEs) by the UE. Moreover, using the direct SCell activation with the semi-persistent CSI-RS activation enables the UE, or the SCell to be activated, to acquire full QCL information (for example, QCL-Type A information) for the TCI state (for example, as a semi-persistent CSI-RS may provide more QCL information than other reference signals). Additionally, using the direct SCell activation with the semi-persistent CSI-RS activation enables the UE to comply with existing reference signal or QCL rules (for example, as defined, or otherwise fixed, by a wireless communication standard).

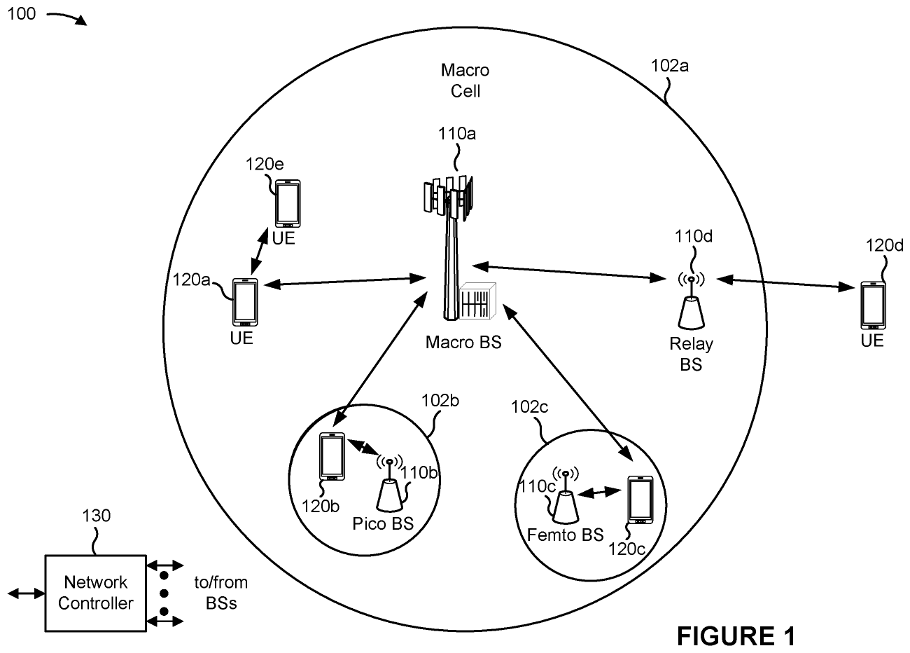

FIG. 1 is a diagram illustrating an example of a wireless network in accordance with the present disclosure. The wireless network may be or may include elements of a 5G New Radio (NR) network or an LTE network, among other examples. The wireless network may include one or more base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, or a transmit receive point (TRP), among other examples. Each BS may provide communication coverage for a particular geographic area. In 3GPP, the term “cell” can refer to a coverage area of a BS or a BS subsystem serving this coverage area, depending on the context in which the term is used.

A BS may provide communication coverage for a macro cell, a pico cell, a femto cell, or another type of cell. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A BS for a macro cell may be referred to as a macro BS. A BS for a pico cell may be referred to as a pico BS. A BS for a femto cell may be referred to as a femto BS or a home BS. A BS may support one or multiple (for example, three) cells.

The wireless network may be a heterogeneous network that includes BSs of different types, such as macro BSs, pico BSs, femto BSs, or relay BSs. These different types of BSs may have different transmit power levels, different coverage areas, and different impacts on interference in the wireless network. For example, macro BSs may have a high transmit power level (for example, 5 to 40 watts) whereas pico BSs, femto BSs, and relay BSs may have lower transmit power levels (for example, 0.1 to 2 watts). In the example shown in FIG. 1, a BS 110a may be a macro BS for a macro cell 102a, a BS 110b may be a pico BS for a pico cell 102b, and a BS 110c may be a femto BS for a femto cell 102c. A network controller 130 may couple to the set of BSs 102a, 102b, 110a and 110b, and may provide coordination and control for these BSs. Network controller 130 may communicate with the BSs via a backhaul. The BSs may also communicate with one another, for example, directly or indirectly via a wireless or wireline backhaul.

In some aspects, a cell may not be stationary, rather, the geographic area of the cell may move in accordance with the location of a mobile BS. In some aspects, the BSs may be interconnected to one another or to one or more other BSs or network nodes (not shown) in the wireless network through various types of backhaul interfaces, such as a direct physical connection or a virtual network, using any suitable transport network.

The wireless network may also include relay stations. A relay station is an entity that can receive a transmission of data from an upstream station (for example, a BS or a UE) and send a transmission of the data to a downstream station (for example, a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, or a relay, among other examples.

UEs 120 (for example, 120a, 120b, 120c) may be dispersed throughout the wireless network, and each UE may be stationary or mobile. A UE may also be referred to as an access terminal, a terminal, a mobile station, a subscriber unit, or a station, among other examples. A UE may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless medium.

Some UEs may be considered machine-type communication (MTC) or evolved or enhanced machine-type communication (eMTC) UEs. MTC and eMTC UEs include, for example, robots, drones, remote devices, sensors, meters, monitors or location tags, among other examples, that may communicate with a base station, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices, or may be implemented as NB-IoT (narrowband internet of things) devices. Some UEs may be considered a Customer Premises Equipment (CPE). UE 120 may be included inside a housing that houses components of UE 120, such as processor components or memory components, among other examples.

In general, any quantity of wireless networks may be deployed in a given geographic area. Each wireless network may support a particular radio access technology (RAT) and may operate on one or more frequencies or frequency channels. A frequency may also be referred to as a carrier among other examples. Each frequency may support a single RAT in a given geographic area in order to avoid interference between wireless networks of different RATs. In some cases, NR or 5G RAT networks may be deployed.

In some aspects, two or more UEs 120 (for example, shown as UE 120a and UE 120e) may communicate directly with one another using one or more sidelink channels (for example, without using a base station 110 as an intermediary). For example, the UEs 120 may communicate using peer-to-peer (P2P) communications, device-to-device (D2D) communications, a vehicle-to-everything (V2X) protocol (for example, which may include a vehicle-to-vehicle (V2V) protocol or a vehicle-to-infrastructure (V2I) protocol), a mesh network, or a combination thereof. In such examples, the UE 120 may perform scheduling operations, resource selection operations, or other operations described elsewhere herein as being performed by the base station 110.

Devices of the wireless network may communicate using the electromagnetic spectrum, which may be subdivided based on frequency or wavelength into various classes, bands, or channels. For example, devices of the wireless network may communicate using an operating band having a first frequency range (FR1), which may span from 410 MHz to 7.125 GHz. As another example, devices of the wireless network may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” may broadly represent frequencies less than 6 GHz, frequencies within FR1, mid-band frequencies (for example, greater than 7.125 GHz), or a combination thereof. Similarly, unless specifically stated otherwise, it should be understood that the term “millimeter wave” may broadly represent frequencies within the EHF band, frequencies within FR2, mid-band frequencies (for example, less than 24.25 GHz), or a combination thereof. The frequencies included in FR1 and FR2 may be modified, and techniques described herein are applicable to those modified frequency ranges.

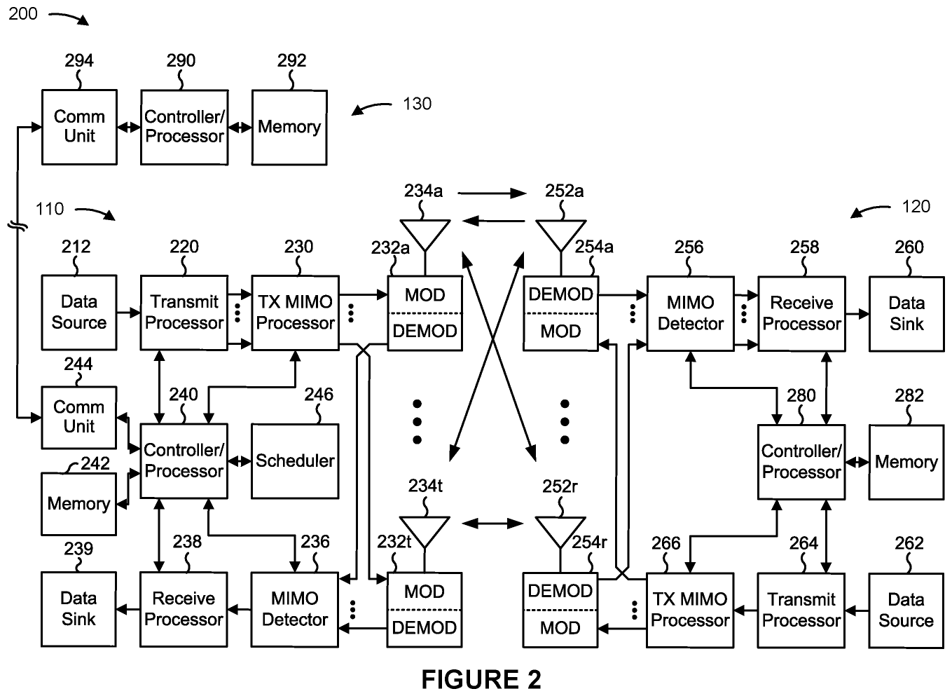

FIG. 2 is a diagram illustrating an example base station in communication with a UE in a wireless network in accordance with the present disclosure. The base station may correspond to base station 110 of FIG. 1. Similarly, the UE may correspond to UE 120 of FIG. 1.

Base station 110 may be equipped with T antennas 234a through 234t, and UE 120 may be equipped with R antennas 252a through 252r, where in general T≥1 and R≥1. At base station 110, a transmit processor 220 may receive data from a data source 212 for one or more UEs, select one or more modulation and coding schemes (MCSs) for each UE based at least in part on channel quality indicators (CQIs) received from the UE, process (for example, encode) the data for each UE based at least in part on the MCS(s) selected for the UE, and provide data symbols for all UEs. Transmit processor 220 may also process system information (for example, for semi-static resource partitioning information (SRPI) among other examples) and control information (for example, CQI requests, grants, or upper layer signaling) and provide overhead symbols and control symbols. Transmit processor 220 may also generate reference symbols for reference signals and synchronization signals. A transmit (TX) multiple-input multiple-output (MIMO) processor 230 may perform spatial processing (for example, precoding) on the data symbols, the control symbols, the overhead symbols, or the reference symbols, if applicable, and may provide T output symbol streams to T modulators (MODs) 232a through 232t. Each MOD 232 may process a respective output symbol stream (for example, for OFDM among other examples) to obtain an output sample stream. Each MOD 232 may further process (for example, convert to analog, amplify, filter, and upconvert) the output sample stream to obtain a downlink signal. T downlink signals from MODs 232a through 232t may be transmitted via T antennas 234a through 234t, respectively.

At UE 120, antennas 252a through 252r may receive the downlink signals from base station 110 or other base stations and may provide received signals to R demodulators (DEMODs) 254a through 254r, respectively. Each DEMOD 254 may condition (for example, filter, amplify, downconvert, and digitize) a received signal to obtain input samples. Each DEMOD 254 may further process the input samples (for example, for OFDM) to obtain received symbols. A MIMO detector 256 may obtain received symbols from all R DEMODs 254a through 254r, perform MIMO detection on the received symbols if applicable, and provide detected symbols. A receive processor 258 may process (for example, decode) the detected symbols, provide decoded data for UE 120 to a data sink 260, and provide decoded control information and system information to a controller/processor 280. The term “controller/processor” may refer to one or more controllers, one or more processors, or a combination of one or more controllers and one or more processors. A channel processor may determine one or more of a reference signal received power (RSRP) parameter, a received signal strength indicator (RSSI) parameter, a reference signal received quality (RSRQ) parameter, or a channel quality indicator (CQI) parameter, among other examples. In some aspects, one or more components of UE 120 may be included in a housing.

Network controller 130 may include communication unit 294, controller/processor 290, and memory 292. Network controller 130 may include, for example, one or more devices in a core network. Network controller 130 may communicate with base station 110 via communication unit 294.

Antennas (such as antennas 234a through 234t or antennas 252a through 252r) may include, or may be included within, one or more antenna panels, antenna groups, sets of antenna elements, or antenna arrays, among other examples. An antenna panel, an antenna group, a set of antenna elements, or an antenna array may include one or more antenna elements. An antenna panel, an antenna group, a set of antenna elements, or an antenna array may include a set of coplanar antenna elements or a set of non-coplanar antenna elements. An antenna panel, an antenna group, a set of antenna elements, or an antenna array may include antenna elements within a single housing or antenna elements within multiple housings. An antenna panel, an antenna group, a set of antenna elements, or an antenna array may include one or more antenna elements coupled to one or more transmission or reception components, such as one or more components of FIG. 2.

On the uplink, at UE 120, a transmit processor 264 may receive and process data from a data source 262 as well as control information (for example, for reports including RSRP, RSSI, RSRQ, or CQI) from controller/processor 280. Transmit processor 264 may also generate reference symbols for one or more reference signals. The symbols from transmit processor 264 may be precoded by a TX MIMO processor 266 if applicable, further processed by MODs 254a through 254r (for example, for discrete Fourier transform spread orthogonal frequency division multiplexing (DFT-s-OFDM) or orthogonal frequency division multiplexing (OFDM) with a cyclic prefix (CP) (CP-OFDM)), and transmitted to base station 110. In some aspects, a modulator and a demodulator (for example, MOD/DEMOD 254) of the UE 120 may be included in a modem of the UE 120. In some aspects, the UE 120 includes a transceiver. The transceiver may include any combination of antenna(s) 252, modulators 254, demodulators 254, MIMO detector 256, receive processor 258, transmit processor 264, or TX MIMO processor 266. The transceiver may be used by a processor (for example, controller/processor 280) and memory 282 to perform aspects of any of the methods described herein.

At base station 110, the uplink signals from UE 120 and other UEs may be received by antennas 234, processed by DEMODs 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and uplink communications. In some aspects, a modulator and a demodulator (for example, MOD/DEMOD 232) of the base station 110 may be included in a modem of the base station 110. In some aspects, the base station 110 includes a transceiver. The transceiver may include any combination of antenna(s) 234, modulators 232, demodulators 232, MIMO detector 236, receive processor 238, transmit processor 220, or TX MIMO processor 230. The transceiver may be used by a processor (for example, controller/processor 240) and memory 242 to perform aspects of any of the methods described herein.

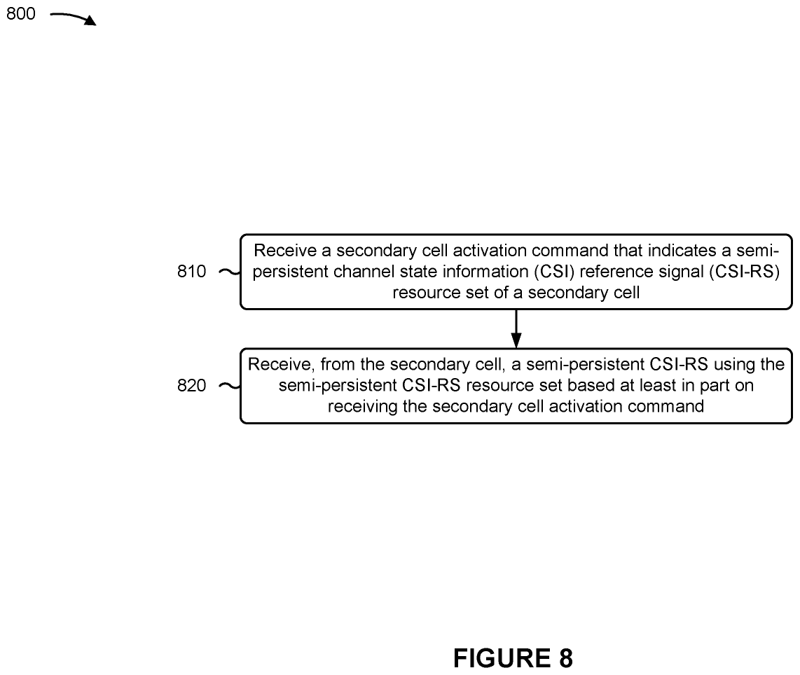

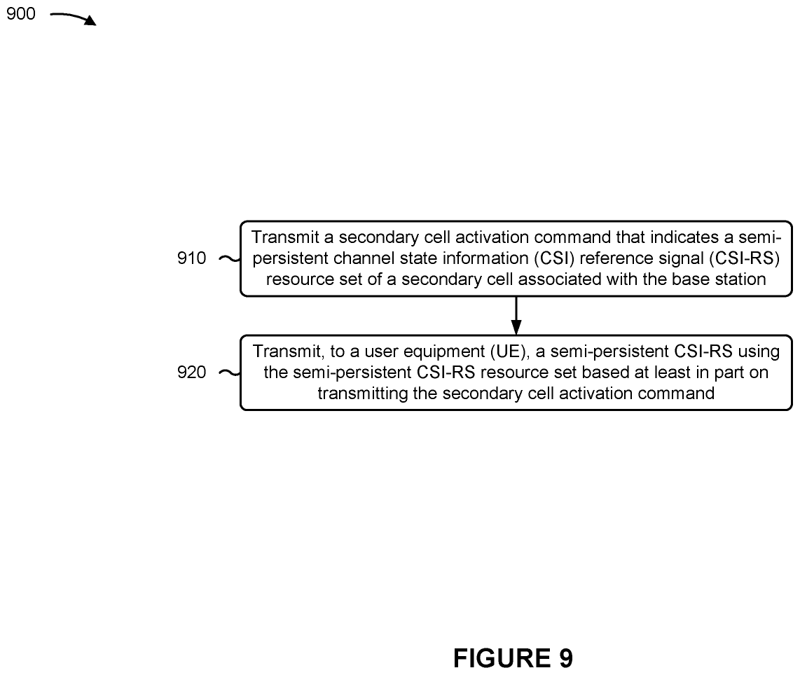

Controller/processor 240 of base station 110, controller/processor 280 of UE 120, or any other component(s) of FIG. 2 may perform one or more techniques associated with semi-persistent CSI-RS activation in a direct SCell activation, as described in more detail elsewhere herein. For example, controller/processor 240 of base station 110, controller/processor 280 of UE 120, or any other component(s) of FIG. 2 may perform or direct operations of, for example, process 800 of FIG. 8, process 900 of FIG. 9, or other processes as described herein. Memories 242 and 282 may store data and program codes for base station 110 and UE 120, respectively. In some aspects, memory 242 or memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, process 800 of FIG. 8, process 900 of FIG. 9, or other processes as described herein. In some aspects, executing instructions may include running the instructions, converting the instructions, compiling the instructions, or interpreting the instructions, among other examples.

In some aspects, the UE 120 includes means for receiving a secondary cell activation command that indicates a semi-persistent CSI-RS resource set of a secondary cell; or means for receiving, from the secondary cell, a semi-persistent CSI-RS using the semi-persistent CSI-RS resource set based at least in part on receiving the secondary cell activation command. The means for the UE 120 to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the base station 110 includes means for transmitting a secondary cell activation command that indicates a semi-persistent CSI-RS resource set of a secondary cell associated with the base station; or means for transmitting, to a UE, a semi-persistent CSI-RS using the semi-persistent CSI-RS resource set based at least in part on transmitting the secondary cell activation command. The means for the base station 110 to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

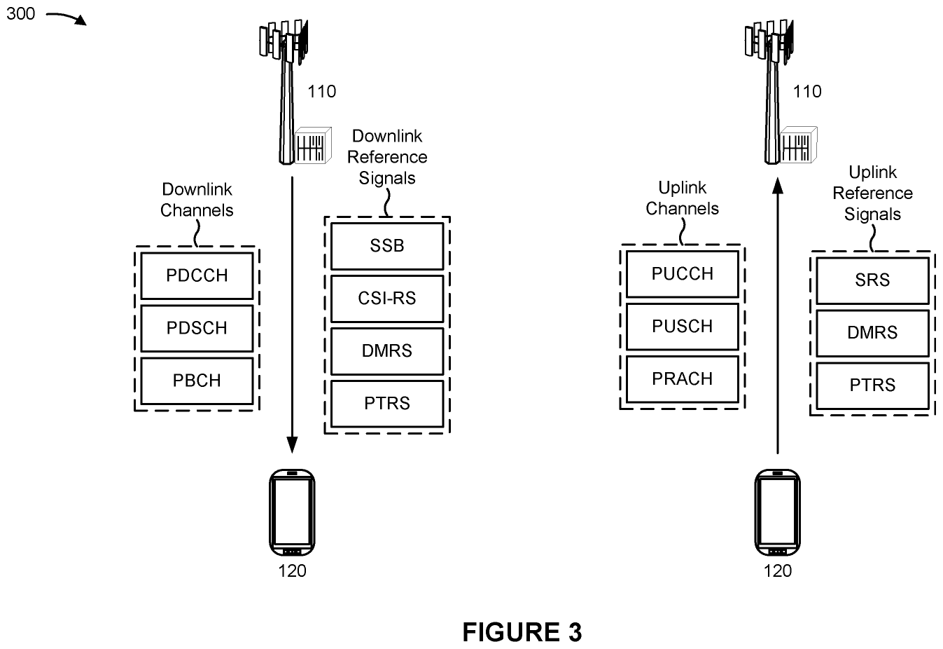

FIG. 3 is a diagram illustrating an example of physical channels and reference signals 300 in a wireless network, in accordance with the present disclosure. As shown in FIG. 3, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some examples, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some examples, the UE 120 may transmit acknowledgement (ACK) or negative acknowledgement (NACK) feedback (for example, ACK/NACK feedback or ACK/NACK information) in UCI on the PUCCH or the PUSCH.

As further shown, a downlink reference signal may include a synchronization signal block (SSB), a CSI-RS, a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some examples, the base station 110 may transmit multiple SSBs on multiple corresponding beams, and the SSBs may be used for beam selection.

A CSI-RS may carry information used for downlink channel estimation (for example, downlink CSI acquisition), which may be used for scheduling, link adaptation, or beam management, among other examples. The base station 110 may configure a set of CSI-RSs (for example, one or more CSI-RS resource sets) for the UE 120, and the UE 120 may measure the configured set of CSI-RSs. Based at least in part on the measurements, the UE 120 may perform channel estimation and may report channel estimation parameters to the base station 110 (for example, in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The base station 110 may use the CSI report to select transmission parameters for downlink communications to the UE 120, such as a quantity of transmission layers (for example, a rank), a precoding matrix (for example, a precoder), a modulation and coding scheme (MCS), or a refined downlink beam (for example, using a beam refinement procedure or a beam management procedure), among other examples.

The base station 110 may configure a CSI-RS resource set to be aperiodic, semi-persistent, or periodic. For an aperiodic CSI-RS resource set, the CSI-RS resource set may be configured such that CSI-RS transmission using the CSI-RS resource set by the base station 110 and CSI-RS monitoring by the UE 120 are aperiodically triggered by DCI that includes an uplink grant (for example, on a PUSCH) or a downlink grant (for example, on a PDSCH). Additionally or alternatively, an aperiodic CSI-RS resource set may be configured such that CSI-RS transmission by the base station 110 and CSI-RS monitoring by the UE 120 are aperiodically triggered by a MAC-CE. For a semi-persistent CSI-RS resource set, the configuration information may be used to configure a semi-persistent transmission (by the base station 110) or monitoring (by the UE 120) for the CSI-RS resource set. One or more parameters of a semi-persistent CSI-RS resource set may be, for example, linked with one or more parameters of a semi-persistent scheduling (SPS) PDSCH. For a periodic CSI-RS resource set, the configuration information may be used to configure a periodicity for a CSI-RS transmission (by the base station 110) and CSI-RS monitoring (by the UE 120). One or more parameters of a periodic CSI-RS resource set may be, for example, linked with one or more parameters of a periodic PDCCH.

In some cases, a CSI-RS resource may be used to transmit a tracking reference signal (TRS). A TRS may be used by the base station 110 or the UE 120 for frequency tracking and time tracking. For example, a TRS may enable the UE 120 to track frequency variations or time variations over time (for example, to improve synchronization between the UE 120 and the base station 110). A TRS may be configured (by the base station 110) to be periodic or aperiodic. In some cases, an aperiodic TRS may be associated with, or linked to, a periodic TRS such that the base station 110 is not enabled to transmit the aperiodic TRS until after the periodic TRS is transmitted.

A DMRS may carry information used to estimate a radio channel for demodulation of an associated physical channel (for example, PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (for example, rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (for example, on the PDSCH) and uplink communications (for example, on the PUSCH).

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (for example, a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (for example, a reference cell and one or more neighbor cells), and may report a reference signal time difference (RSTD) based on OTDOA measurements associated with the PRSs received from the multiple cells. In some examples, the base station 110 may then calculate a position of the UE 120 based on the RSTD measurements reported by the UE 120. In some cases, a PRS may be transmitted using a CSI-RS resource.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

In some cases, a reference signal may be a source reference signal for a transmission configuration indicator (TCI) state. For example, the UE 120 may use the source reference signal to obtain quasi-colocation (QCL) properties or information associated with the TCI state (as described in more detail below). For example, the UE 120 may receive the source reference signal (such as an SSB or a CSI-RS) and determine QCL priorities or information for a TCI state (for example, for a beam) based at least in part on the source reference signal. In some cases, different reference signals may be capable of providing different types of QCL information. For example, an SSB may not be capable of providing QCL type A and QCL type D information (as defined, or otherwise fixed, by a wireless communication standard) for a downlink control channel (such as a PDCCH) or a downlink data (shared) channel (such as a PDSCH), but a CSI-RS may be capable of providing QCL type A and QCL type D information for the downlink control or downlink data (shared) channel.

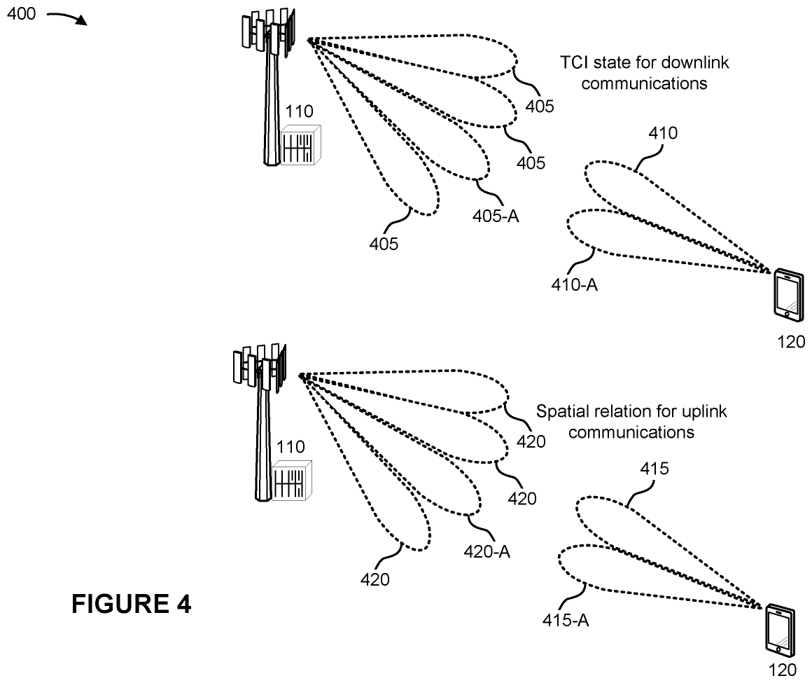

FIG. 4 is a diagram illustrating an example of using beams for communications 400 between a base station and a UE, in accordance with the present disclosure. As shown in FIG. 4, a base station 110 and a UE 120 may communicate with one another. For example, the base station 110 may transmit to UEs 120 located within a coverage area of the base station 110.

The base station 110 and the UE 120 may be configured for beamformed communications, where the base station 110 may transmit in the direction of the UE 120 using a directional BS transmit beam, and the UE 120 may receive the transmission using a directional UE receive beam. Each base station transmit beam may have an associated beam identifier (ID), beam direction, or beam symbols, among other examples. The base station 110 may transmit downlink communications via one or more base station transmit beams 405.

The UE 120 may attempt to receive downlink transmissions via one or more UE receive beams 410, which may be configured using different beamforming parameters at receive circuitry of the UE 120. The UE 120 may identify a particular base station transmit beam 405, shown as base station transmit beam 405-A, and a particular UE receive beam 410, shown as UE receive beam 410-A, that provide relatively favorable performance (for example, that have a best channel quality relative to other channels of the different measured combinations of base station transmit beams 405 and UE receive beams 410). In some examples, the UE 120 may transmit an indication of which base station transmit beam 405 is identified by the UE 120 as a preferred base station transmit beam, which the base station 110 may select for transmissions to the UE 120. The UE 120 may thus attain and maintain a beam pair link (BPL) with the base station 110 for downlink communications (for example, a combination of the base station transmit beam 405-A and the UE receive beam 410-A), which may be further refined and maintained in accordance with one or more established beam refinement procedures.

A downlink beam, such as a base station transmit beam 405 or a UE receive beam 410, may be associated with a TCI state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. In some examples, each base station transmit beam 405 may be associated with an SSB (or another reference signal, such as a CSI-RS), and the UE 120 may indicate a preferred base station transmit beam 405 by transmitting uplink transmissions in resources of the SSB that are associated with the preferred base station transmit beam 405. A particular SSB may have an associated TCI state (for example, for an antenna port or for beamforming). The base station 110 may, in some examples, indicate a downlink base station transmit beam 405 based at least in part on antenna port QCL properties that may be indicated by the TCI state. A TCI state may be associated with one downlink reference signal set (for example, an SSB and an aperiodic CSI-RS, a periodic CSI-RS, or a semi-persistent CSI-RS) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 410 at the UE 120. Thus, the UE 120 may select a corresponding UE receive beam 410 from a set of BPLs based at least in part on the base station 110 indicating a base station transmit beam 405 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a PDSCH. The set of activated TCI states for downlink control channel communications may correspond to beams that the base station 110 may use for downlink transmission on a PDCCH or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

In some cases, a TCI state may indicate one or more QCL rules, where a QCL rule associates a reference signal (such as an SSB, a CSI-RS, or another reference signal) with associated channel properties (such as a Doppler shift, a Doppler spread, an average delay, a delay spread, one or more spatial parameters (such as a spatial filter), or other properties). Such QCL rules may include QCL-Type A, QCL-Type B, QCL-Type C, or QCL-Type D data structures as defined, or otherwise fixed, by 3GPP specifications. QCL-Type A information may include a Doppler shift, a Doppler spread, an average delay, and a delay spread. QCL-Type A information may be used to obtain CSI for a channel. QCL-Type B information may include a Doppler shift, and a Doppler spread. QCL-Type B information may be used to obtain CSI for a channel. QCL-Type C information may include an average delay and a delay spread. QCL-Type C information may be used to obtain measurement information, such as RSRP measurement information. QCL-Type D information may include a spatial receive parameter. QCL-Type D information may be used to support beamforming. In some cases, QCL rules may indicate QCL information provided by different reference signals. For example, a QCL rule may indicate that an SSB may provide QCL-Type C information or QCL-Type D information (for example, after RRC signaling or after a CSI-RS is configured). As another example, a QCL rule may indicate that a CSI-RS (or a TRS) may provide QCL-Type A information. As described above, QCL rules (and the type of QCL information provided by different reference signals) may be defined, or otherwise fixed, by the 3GPP.

In some cases, the base station 110 may transmit an indication of a TCI state that indicates one or more reference signals providing a UE with properties for a common beam. A beam may be “common” when the beam is used by the UE to transmit data or control information on the uplink as well as used by the UE to receive data or control information on the downlink. A TCI state that indicates properties for a common beam may be referred to as a joint downlink and uplink TCI state, or a unified TCI state. A unified TCI state may indicate multiple beams. For example, a unified TCI state may be associated with, or otherwise applied to, one or more uplink channels, uplink reference signals, downlink channels, or downlink reference signals.

In some cases, a TCI state may be associated with a TCI chain that indicates one or more source reference signals for the TCI state. “Source reference signal” may refer to a reference signal that can be used to obtain QCL information for a TCI state. In some cases, a TCI chain may indicate one or more source reference signals. For example, a TCI chain may indicate an SSB and one or more CSI-RS resources that can be used as source reference signals for a TCI state. For example, one reference signal may be considered to be quasi-collocated with another reference signal if both reference signals are included in the same TCI chain. In some cases, a TCI chain may be associated with a single QCL type. In some cases, a DMRS (for example, of a PDCCH or a PDSCH) may be quasi-collocated with a source reference signal associated with an active TCI state. For example, the DMRS may be quasi-collocated with one or more reference signals indicated in a TCI chain associated with the TCI state.

Similarly, for uplink communications, the UE 120 may transmit in the direction of the base station 110 using a directional UE transmit beam, and the base station 110 may receive the transmission using a directional base station receive beam. Each UE transmit beam may have an associated beam ID, beam direction, or beam symbols, among other examples. The UE 120 may transmit uplink communications via one or more UE transmit beams 415.

The base station 110 may receive uplink transmissions via one or more base station receive beams 420. The base station 110 may identify a particular UE transmit beam 415, shown as UE transmit beam 415-A, and a particular base station receive beam 420, shown as base station receive beam 420-A, that provide relatively favorable performance (for example, that have a best channel quality of the different measured combinations of UE transmit beams 415 and base station receive beams 420). In some examples, the base station 110 may transmit an indication of which UE transmit beam 415 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 415-A and the BS receive beam 420-A), which may be further refined and maintained in accordance with one or more established beam refinement procedures. An uplink beam, such as a UE transmit beam 415 or a base station receive beam 420, may be associated with a spatial relation. A spatial relation may indicate a directionality or a characteristic of the uplink beam, similar to one or more QCL properties, as described above.

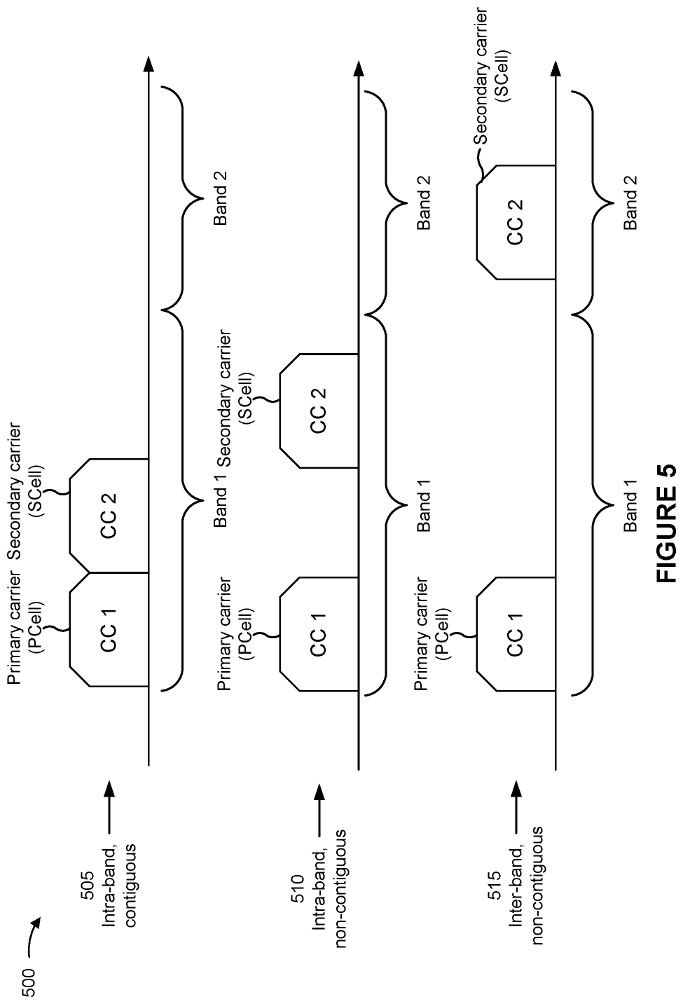

In some cases, a UE may use dual connectivity to connect to multiple cells at once. For example, the UE may select a set of candidate cells, and may select one or more primary cells (PCells), secondary cells (SCells), primary secondary cells (PSCells), or secondary primary cells or special cells (SPCells). The PCell and SCell may be referred to as serving cells. In some examples, “SPCell” may refer to a PCell of a master cell group or a PSCell of a secondary cell group, or to the PCell. “Primary cell” or “PCell” may refer to a cell, operating on a primary frequency, in which the UE either performs the initial connection establishment procedure with or initiates the connection re-establishment procedure, or the cell indicated as the primary cell in a handover procedure. “Secondary cell” or “SCell” may refer to a cell, operating on a secondary frequency, which may be configured once an RRC connection is established (for example, with a PCell) and which may be used to provide additional radio resources for the UE. For example, in some cases, a PCell may be used by the UE for a control plane connection (such as to a core network) and a data plane connection, whereas an SCell may be used by the UE only for a data plane connection. An SCell may be an SCell in a standalone carrier aggregation configuration (as described in more detail below with reference to FIG. 5) or an SCell in a dual connectivity mode, such as an Evolved Universal Mobile Telecommunications System Terrestrial Radio Access (E-UTRA)-NR dual connectivity (ENDC) mode, an NR-E-UTRA dual connectivity (NEDC) mode, an NR dual connectivity (NRDC) mode, or another dual connectivity mode.

FIG. 5 is a diagram illustrating examples of carrier aggregation 500, in accordance with the present disclosure. Carrier aggregation is a technology that enables two or more component carriers (CCs, sometimes referred to as carriers) to be combined (for example, into a single channel) for a single UE 120 to enhance data capacity. As shown, carriers can be combined in the same or different frequency bands. Additionally or alternatively, contiguous or non-contiguous carriers can be combined. A base station 110 may configure carrier aggregation for a UE 120, such as in an RRC message, a DCI, or another signaling message.

In some cases, carrier aggregation may be configured in an intra-band contiguous mode 505 where the aggregated carriers are contiguous to one another and are in the same band. In some other cases, carrier aggregation may be configured in an intra-band non-contiguous mode 510 where the aggregated carriers are non-contiguous to one another and are in the same band. In some other cases, carrier aggregation may be configured in an inter-band non-contiguous mode 515 where the aggregated carriers are non-contiguous to one another and are in different bands.

In carrier aggregation, a UE 120 may be configured with a primary carrier or PCell and one or more secondary carriers or SCells (as shown in FIG. 5). In some cases, the primary carrier may carry control information (for example, downlink control information or scheduling information) for scheduling data communications on one or more secondary carriers, which may be referred to as cross-carrier scheduling. In some cases, a carrier (for example, a primary carrier or a secondary carrier) may carry control information for scheduling data communications on the carrier, which may be referred to as self-carrier scheduling or carrier self-scheduling.

When carrier aggregation is used, there may be one or more serving cells, for example, one for each carrier. The coverage of the serving cells may differ, for example due to different carriers on different frequency bands experiencing different pathloss. A primary serving cell (for example, a PCell) is served by the primary carrier. One or more secondary serving cells (for example, SCells)) are served by one or more secondary carriers. An SCell may be activated or deactivated in order to enable carrier aggregation for a UE using one or more secondary carriers.

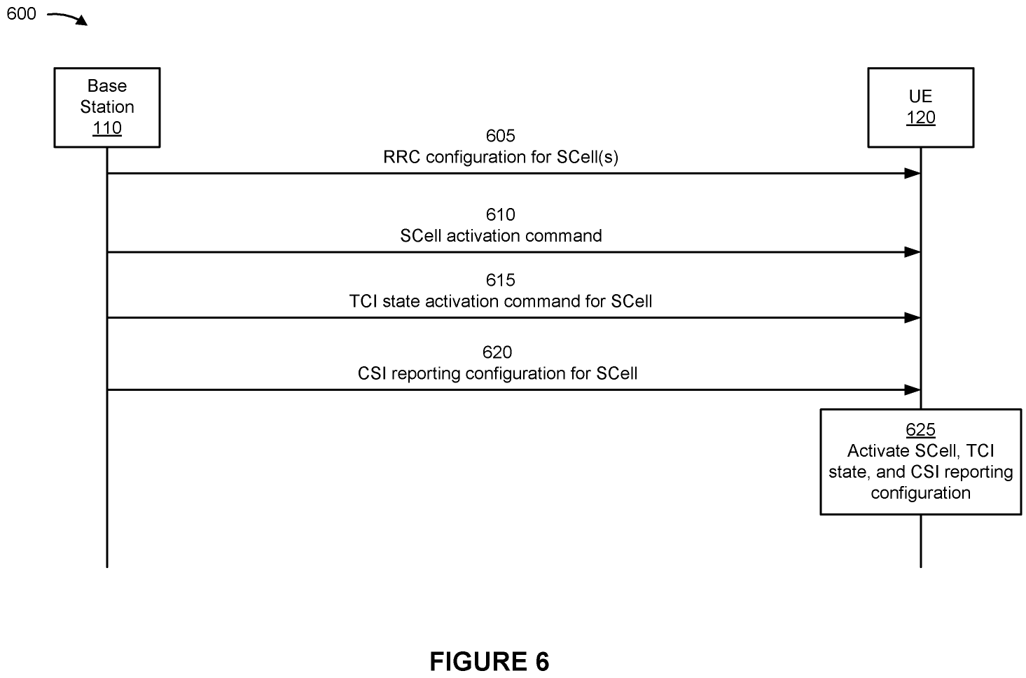

FIG. 6 is a diagram illustrating an example associated with an SCell activation procedure 600, in accordance with the present disclosure. As shown in FIG. 6, a base station 110 and a UE 120 may communicate with one another in a wireless network, such as wireless network 100. For example, the base station 110 and the UE 120 may communicate with one another to activate a SCell. In some cases, the base station 110 may be associated with a PCell or a primary carrier. In some other cases, the base station 110 may be associated with an activated SCell.

In a first operation 605, the base station 110 may transmit, and the UE 120 may receive, an RRC configuration for one or more SCells. For example, the RRC configuration for an SCell may indicate an identifier associated with the SCell, such as a cell identifier (a physical cell identifier (PCI) or a cell global identifier (CGI)). Additionally or alternative, the RRC configuration for the SCell may indicate other RRC parameters associated with the SCell. In some cases, a UE may be configured with one or more SCells.

An SCell can be switched between an activated state and a deactivated state. When the SCell is in the deactivated state for the UE 120, the UE 120 does not perform channel measurements (for example, CSI-RS measurements) for the SCell, does not monitor a physical downlink control channel (PDCCH) for the SCell, and does not transmit uplink data or receive downlink data on the SCell. The activated state of an SCell may include a non-dormant state and a dormant state. For example, when the SCell is in the non-dormant state (an activated state) for the UE 120, the UE 120 may measure and report channel measurements (for example, CSI-RS measurements) for the SCell, may monitor a PDCCH for the SCell, may receive downlink data (for example, via downlink grants) on the SCell, and may transmit uplink data (for example, via uplink grants) on the SCell. When the SCell is in the dormant state for the UE 120, the UE 120 does not perform PDCCH monitoring for the SCell, but the UE 120 may perform channel measurements (for example, CSI-RS measurements) for the SCell. No uplink or downlink grants may be enabled for the UE 120 on the Scell in the dormant state. Accordingly, a UE 120 may not be enabled to transmit uplink data or receive downlink data on the SCell when the SCell is in the dormant state.

In a second operation 610, the base station 110 may transmit, and the UE 120 may receive, an SCell activation command. For example, the base station 110 may activate an SCell (for example, an SCell configured in the RRC configuration) using the SCell activation command. The SCell activation command may switch the SCell from the deactivated state to an activated state. For example, the SCell activation command may be transmitted using a medium access control (MAC) control element (MAC-CE).

In some cases, the UE 120 may determine a TCI state for the SCell based on a TCI state that is currently configured for a downlink channel (for example, a TCI state for a PCell). For example, the UE 120 may use a current TCI state for the downlink channel for any serving cells (for example, the PCell and any activated SCells). Therefore, in some cases, a TCI state may not need to be activated when activating an SCell. However, in some other cases, an SCell activation may need a TCI state activation to activate a TCI state for the SCell. For example, in a third operation 615, the base station 110 may transmit, and the UE 120 may receive, a TCI state activation command to activate a TCI state for the SCell. The TCI state activation command may be transmitted using a MAC-CE. For example, the TCI state activation command may indicate a source reference signal to be used by the UE 120 to obtain QCL information for the TCI state.

In some cases, to enable the UE 120 to perform measurements (for example, CSI-RS measurements) on the activated SCell, a CSI reporting configuration may need to be activated for, or indicated to, the UE 120. For example, in a fourth operation 620, the base station 110 may transmit, and the UE 120 may receive, a CSI reporting configuration (for example, a CSI report activation command) for the SCell. The CSI reporting configuration may indicate measurement resources (for example, CSI-RS resource set(s)) to be used by the UE 120 to perform measurements on the SCell. For example, CSI measurement and reporting may be based at least in part on the CSI reporting configuration. A CSI reporting configuration may be semi-statically configured (for example, using RRC signaling or MAC-CE signaling). The CSI reporting configuration may identify a periodicity for CSI reporting, a reference signal for CSI reporting, or a resource associated with CSI reporting, among other examples. CSI reporting can be performed periodically, semi-persistently, or aperiodically. Aperiodic CSI reporting can be triggered, whereas periodic and semi-persistent CSI reporting can be configured to be performed in accordance with an interval.

In a fifth operation 625, the UE 120 may activate the SCell based on receiving the SCell activation command, the TCI state activation command, or the CSI reporting configuration. For example, the UE 120 may perform channel measurements (for example, CSI-RS measurements) for the SCell, may monitor a PDCCH for the SCell, or may transmit uplink data or receive downlink data on the SCell, among other examples. However, there may be some delay associated with the UE 120 activating the SCell. The delay associated with the UE 120 activating a deactivated SCell depends upon one or more conditions. For example, UE SCell activation and deactivation delay requirements may be defined, or otherwise fixed, by a 3GPP Specification. In some cases, upon receiving an SCell activation command in a slot n, the UE 120 may be enabled to transmit a valid CSI report and apply actions related to the SCell activation command no later than in slot

$$n + \frac{{T}_{HARQ} + {T}_{activation \_ time} + {T}_{CSI \_ Reporting}}{slot length}$$

where T_{HARQ} is a timing delay between downlink data transmission (for example, by the base station 110) and an acknowledgement feedback transmission (for example, by the UE 120), T_{activation_time} is an SCell activation delay, and T_{CSI_Reporting} is the delay uncertainty in acquiring a first available CSI reporting resource. Therefore, as described above, where separate MAC-CE messages are transmitted at different times for the SCell activation, the TCI state activation, and the CSI report activation significant latency may be introduced in activating a SCell. For example, each MAC-CE message may be associated with some additional delay time associated with a processing time for the MAC-CE, such as 3 milliseconds. Therefore, the conditions described above related to the SCell activation delay requirements may be associated with additional delays when using multiple messages (for example, multiple MAC-CEs) for the SCell activation, the TCI state activation, and the CSI report activation.

Therefore, in some cases, a direct SCell activation may be used to activate a SCell. “Direct SCell activation” may refer to an SCell activation command that also indicates TCI state information for the SCell to be activated. Indicating the TCI state information (for example, activating a TCI state for the SCell) with the SCell activation command may reduce latency associated with activating the SCell by eliminating the need for a separate message (for example, a separate MAC-CE) to activate the TCI state for the SCell. In some cases, a direct SCell activation may indicate an SSB to be used as a source reference signal for the TCI state activation. For example, the UE 120 may use the indicated SSB to obtain QCL information for the TCI state associated with the SCell to be activated (for example, if the SCell is a known SCell as defined, or otherwise fixed, by the 3GPP). However, an SSB may not provide full QCL information for the TCI state. For example, as described above, an SSB may not provide QCL-Type A or QCL-Type D information for the downlink control channel or the downlink shared channel. Therefore, the UE 120 may not be enabled to obtain full QCL information (for example, QCL-Type A information) for the downlink channel associated with the SCell when the direct SCell activation command indicates an SSB as the source reference signal to be used for the TCI state activation for the Scell.

However, using a reference signal other than the SSB as the source reference signal to be used for the TCI state activation for the Scell may introduce difficulties due to QCL rules or other reference signal rules. For example, a TRS (transmitted using a CSI-RS resource) can be used as a source reference signal. However, in some cases, an aperiodic TRS (for example, an aperiodic CSI-RS) may be associated with (for example, linked or coupled to) a periodic TRS such that the base station may not be enabled to transmit an aperiodic TRS until the associated periodic TRS is transmitted. This introduces additional latency as the periodic TRS may be associated with a periodicity or an amount of time between transmissions (for example, indicated in an RRC configuration). Therefore, using an aperiodic TRS or an aperiodic CSI-RS may introduce additional latency associated with a delay introduced by the QCL rules or other reference signal rules indicating that the aperiodic TRS or an aperiodic CSI-RS is not to be transmitted until after an associated periodic TRS or periodic CSI-RS is transmitted.

Various aspects relate generally to activating a semi-persistent CSI-RS resource set with a direct SCell activation. Some aspects more specifically relate to an SCell activation command (for example, a direct SCell activation command) that is transmitted by a cell, such as a PCell or an activated SCell, indicating a semi-persistent CSI-RS resource set of a SCell, a TCI state of the SCell, or a CSI reporting configuration for the SCell. In some aspects, the SCell activation command may trigger, or otherwise cause, a transmission of a semi-persistent CSI-RS by the SCell to be activated (for example, using the semi-persistent CSI-RS resource set indicated by, or with, the SCell activation command). In some aspects, a UE may receive the semi-persistent CSI-RS and report a measurement of the semi-persistent CSI-RS to the SCell to be activated in a CSI report (for example, based at least in part on the CSI reporting configuration). In some aspects, the UE or the SCell may use the semi-persistent CSI-RS as a source reference signal for a TCI state of the SCell (for example, a TCI state indicated by, or with, the SCell activation command). For example, the UE or the SCell may obtain QCL information for a downlink channel (a downlink control channel or a downlink shared channel) or may obtain a spatial transmit filter parameter for an uplink channel (an uplink control channel or an uplink shared channel) based at least in part on the semi-persistent CSI-RS. In some aspects, the TCI state for the SCell may be a unified TCI state (for example, a TCI state that indicates information for one or more channels).

Particular aspects of the subject matter described in this disclosure can be implemented to realize one or more of the following potential advantages. In some examples, the described techniques can be used to reduce latency associated with activating an SCell. For example, using the direct SCell activation with the semi-persistent CSI-RS activation may enable a TCI state to be activated for the SCell, a source reference signal for the TCI state to be indicated, and for a CSI report to be activated without the transmission of multiple, separate, messages (for example, without the transmission of multiple MAC-CEs or DCI messages). This reduces latency that would otherwise be associated with processing the multiple messages (for example, with processing multiple MAC-CEs) by the UE. Moreover, using the direct SCell activation with the semi-persistent CSI-RS activation enables the UE, or the SCell to be activated, to acquire full QCL information (for example, QCL-Type A information) for the TCI state (for example, as a semi-persistent CSI-RS may provide more QCL information than other reference signals). Additionally, using the direct SCell activation with the semi-persistent CSI-RS activation enables the UE to comply with existing reference signal or QCL rules (for example, as defined, or otherwise fixed, by a wireless communication standard).

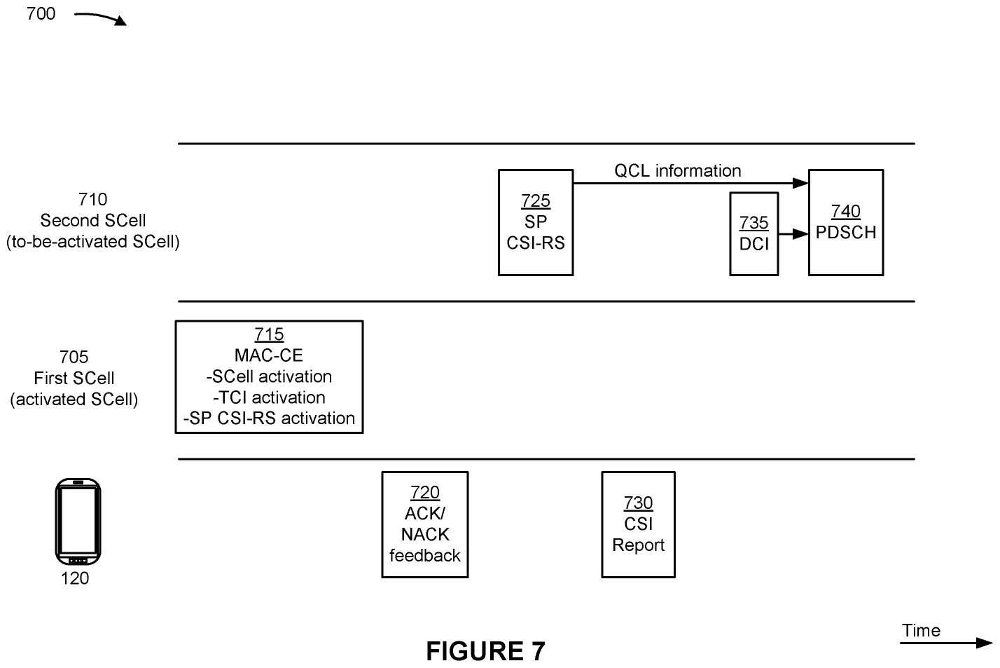

FIG. 7 is a diagram illustrating an example associated with semi-persistent CSI-RS activation in a direct SCell activation 700, in accordance with the present disclosure. As shown in FIG. 7, a UE 120 may be configured with a first cell, and specifically, a first SCell 705. The first SCell 705 may be an activated SCell for the UE 120. The first SCell 705 may be associated with, or served by, a base station 110. In some other aspects, the first cell may be a PCell (rather than an SCell). As shown in FIG. 7, a second SCell 710 may be an SCell that is to be activated for the UE 120. For example, the second SCell 710 may be a configured SCell or a deactivated SCell. In some aspects, the first SCell 705 and the second SCell 710 may be associated with, or served by, the same base station 110. In some other aspects, the first SCell 705 and the second SCell 710 may be associated with, or served by, different base stations 110.

In a first operation 715, the first SCell 705 (for example, a base station 110) may transmit, and the UE 120 may receive, an SCell activation command. Similarly, in some aspects, the first SCell 705 may transmit, and the second SCell 710 may receive, the SCell activation command. The SCell activation command may be a direct SCell activation command (for example, the SCell activation command may also indicate TCI state information for the second SCell 710).

In some aspects, the SCell activation command may indicate a semi-persistent CSI-RS resource set (for example, one or more semi-persistent CSI-RS resources) associated with the second SCell 710. For example, the SCell activation command may indicate an identifier of the semi-persistent CSI-RS resource set. In some aspects, the semi-persistent CSI-RS resource set may be configured at the UE 120 (for example, by a base station 110, a PCell, or the first SCell 705). The SCell activation command may activate (for example, indicate) the semi-persistent CSI-RS resource set associated with the second SCell 710. Therefore, the SCell activation command may also activate the semi-persistent CSI-RS resource set. Activating the semi-persistent CSI-RS resource set may enable the second SCell 710 to transmit, and may enable the UE 120 to receive, one or more semi-persistent CSI-RSs (or TRSs) using the semi-persistent CSI-RS resource set. For example, by indicating the semi-persistent CSI-RS resource set in the SCell activation command, the second SCell 710 may be triggered to transmit a reference signal (for example, a CSI-RS or a TRS) using the indicated semi-persistent CSI-RS resource set.

In some aspects, the SCell activation command may activate, or indicate, a CSI reporting configuration. For example, the CSI reporting configuration may indicate one or more parameters to be used by the UE 120 to report measurements associated with the activated semi-persistent CSI-RS resource set. For example, the CSI reporting configuration may identify a periodicity and a time offset for CSI reporting, a reference signal for CSI reporting (for example, the semi-persistent CSI-RS resource set), or a resource associated with CSI reporting (for example, a resource to be used by the UE 120 to transmit a CSI report), among other examples. In some aspects, the SCell activation command may implicitly indicate the CSI reporting configuration by indicating the semi-persistent CSI-RS resource set. For example, the semi-persistent CSI-RS resource set may be associated with a CSI reporting configuration. In other words, when the semi-persistent CSI-RS resource set is configured, the CSI reporting configuration to be used with the semi-persistent CSI-RS resource set may also be configured. Therefore, when the semi-persistent CSI-RS resource set is activated (for example, with the SCell activation command), the UE 120 may identify the CSI reporting configuration based at least in part on the indicated (or activated) semi-persistent CSI-RS resource set.

In some aspects, the SCell activation command may indicate a TCI state associated with the second SCell 710. For example, the SCell activation command may activate a TCI state of the second SCell 710. In other words, the SCell activation command may include, or indicate, a TCI state activation for the second SCell 710. In some aspects, a semi-persistent CSI-RS transmitted using the semi-persistent CSI-RS resource set may be used as a source reference signal for the TCI state associated with the second SCell 710. For example, the semi-persistent CSI-RS may be used to obtain QCL information for the TCI state associated with the second SCell 710 (the activated TCI state). In some aspects, the TCI state associated with the second SCell 710 may be configured (at the UE 120) when the second SCell 710 is configured (at the UE 120), such as in an RRC configuration. Therefore, the SCell activation command may indicate an identifier associated with the TCI state to activate the TCI state for the second SCell 710.

In some aspects, the SCell activation command may implicitly indicate (or activate) the TCI state associated with the second SCell 710 by indicating the semi-persistent CSI-RS resource set. For example, as described above, the semi-persistent CSI-RS resource set may be configured as a source reference signal (for example, in a TCI chain) for the TCI state associated with the second SCell 710. Therefore, by activating the semi-persistent CSI-RS resource set, the TCI state may be implicitly activated.

In some aspects, the TCI state associated with the second SCell 710 may be a unified TCI state or a joint uplink and downlink TCI state. For example, the TCI state of the second SCell 710 may indicate a joint uplink and downlink common TCI state for at least one downlink channel and at least one uplink channel. In other words, the TCI state of the second SCell 710 may indicate a common beam for at least one downlink channel (or at least one downlink reference signal) and at least one uplink channel (or at least one uplink reference signal). Additionally or alternatively, the TCI state of the second SCell 710 may indicate a separate downlink common TCI state for at least two downlink channels. For example, the TCI state of the second SCell 710 may indicate a common beam for at least two downlink channels (or at least two downlink reference signals).

Additionally or alternatively, the TCI state of the second SCell 710 may indicate a separate uplink common TCI state for at least two uplink channels. For example, the TCI state of the second SCell 710 may indicate a common beam for at least two uplink channels (or at least two uplink reference signals). Additionally or alternatively, the TCI state of the second SCell 710 may indicate a single channel TCI state for a downlink channel. For example, the TCI state of the second SCell 710 may indicate a beam for a downlink channel (or a downlink reference signal). Additionally or alternatively, the TCI state of the second SCell 710 may indicate a single channel TCI state for an uplink channel. For example, the TCI state of the second SCell 710 may indicate a beam for an uplink channel (or an uplink reference signal).

As shown in FIG. 7, the SCell activation command (and the other activations described above) may be transmitted using as MAC-CE. For example, in some aspects, a single MAC-CE may indicate the SCell activation, the semi-persistent CSI-RS resource set activation, the TCI state activation, or the CSI reporting activation. In some other aspects, multiple MAC-CEs may be transmitted at the same time (or substantially in the same PDSCH) to indicate the SCell activation, the semi-persistent CSI-RS resource set activation, the TCI state activation, and the CSI reporting activation.

In a second operation 720, the UE 120 may transmit, and the first SCell 705 may receive, a feedback message associated with the SCell activation command (for example, associated with the one or more MAC-CEs transmitted). The feedback message may include ACK or NACK feedback. For example, the UE 120 may transmit an indication that the SCell activation command has been successfully received or decoded by the UE 120. As a result, the UE 120, the first SCell 705, or the second SCell 710 may proceed with the activation of the second SCell 710. For example, as described above, a MAC-CE may be associated with a delay (such as 3 milliseconds). For example, the delay may be the T_{HARQ} timing delay between downlink data transmission (for example, by a base station 110) and an acknowledgement feedback transmission (for example, by the UE 120). As the SCell activation command (and the other activations described above) may be transmitted using a single MAC-CE (or multiple MAC-CEs transmitted at the same time) latency associated with the activation of the second SCell 710 may be reduced as the UE 120 (and the second SCell 710) may not need to wait for multiple delays (such as multiple 3 milliseconds) associated with multiple MAC-CEs (for the different activations described above) that would have otherwise been transmitted at different times.

In a third operation 725, the second SCell 710 may transmit, and the UE 120 may receive, a semi-persistent CSI-RS using the semi-persistent CSI-RS resource set indicated by the SCell activation command, as described above. For example, the activation of the semi-persistent CSI-RS resource set (for example, in a MAC-CE associated with the SCell activation command) may trigger the second SCell 710 to transmit the semi-persistent CSI-RS using the semi-persistent CSI-RS resource set. For example, the semi-persistent CSI-RS resource set may be a CSI-RS resource set for beam management or CSI acquisition. For example, the semi-persistent CSI-RS may be a beam management signal (such as a signal associated with a beam management procedure). In some aspects, the semi-persistent CSI-RS may be a CSI acquisition signal. In some other aspects, the semi-persistent CSI-RS may be a TRS. In some other aspects, the semi-persistent CSI-RS may be a PRS.

As described above, the semi-persistent CSI-RS may be a source reference signal for the activated TCI state associated with the second SCell 710. For example, the UE 120 may receive the semi-persistent CSI-RS and may obtain QCL information associated with the TCI state based at least in part on the received semi-persistent CSI-RS. In some aspects, the QCL information may be QCL-Type A information or QCL-Type D information, among other examples. For example, as described above, the semi-persistent CSI-RS may be capable of providing full QCL information (for example, a semi-persistent CSI-RS may be capable of providing more QCL information than QCL information that can be provided by an SSB). Therefore, the UE 120 may be enabled to obtain the full QCL information for the TCI state associated with the second SCell 710 based at least in part on the semi-persistent CSI-RS transmitted by the second SCell 710. In other words, the UE 120 may be enabled to obtain information for a beam associated with the second SCell 710 (for example, to be used for one or more uplink channels or one or more downlink channels) based at least in part on receiving the semi-persistent CSI-RS. The QCL information provided by the semi-persistent CSI-RS may be used by the UE 120 for downlink reception (for example, of a PDSCH message as explained in more detail below). Additionally or alternatively, the QCL information provided by the semi-persistent CSI-RS may be used by the UE 120 for uplink transmission. For example, the UE 120 may use information provided by the semi-persistent CSI-RS to determine a spatial transmit filter for uplink transmission (for example, on an uplink channel associated with the second SCell 710).

In a fourth operation 730, the UE 120 may transmit, and the second SCell 710 may receive, a CSI report based at least in part on a measurement of the semi-persistent CSI-RS. For example, as described above, the SCell activation command may activate, or indicate, a CSI reporting configuration for the UE 120. For example, the CSI reporting configuration may configure the UE 120 to report a CSI report. The CSI report may be used by the UE 120 or the second SCell 710 for CSI acquisition. In some aspects, the CSI report may be a Layer 1 (L1) RSRP report. In some aspects, the CSI report may be a Layer 1 (L1) signal-to-interference-plus-noise ratio (SINR) report.

For example, the UE 120 may perform one or more measurements of the semi-persistent CSI-RS transmitted by the second SCell 710. In some aspects, the UE 120 may measure an RSRP of the semi-persistent CSI-RS. Additionally or alternatively, the UE 120 may measure an SINR of the semi-persistent CSI-RS. The UE 120 may generate a CSI report (for example, an L1-RSRP report or an L1-SINR report) in accordance with the CSI reporting configuration. The UE 120 may transmit the CSI report (for example, indicating one or more measurements of the semi-persistent CSI-RS) in accordance with the CSI reporting configuration. For example, the UE 120 may transmit the CSI report using a resource (for example, a time domain and frequency domain resource) indicated by the CSI reporting configuration. The UE 120 may transmit the CSI report using a timing (for example, a periodicity) indicated by the CSI reporting configuration.

Transmitting the CSI report may enable the second SCell 710 to obtain CSI for the channel associated with the semi-persistent CSI-RS. For example, the second SCell may determine a channel condition or a channel quality for the channel associated with the semi-persistent CSI-RS based at least in part on the CSI report. As a result, the second SCell 710 may be enabled to determine one or more transmit parameters (for example, a beam or a transmit power, among other examples) for future communications for the UE 120 on the second SCell 710. Based at least in part on receiving the CSI report (for example, by a base station 110 associated with the second SCell 710), the base station 110 associated with the second SCell 710 may determine that the second SCell 710 is activated. Therefore, by activating the CSI reporting configuration with the SCell activation command (for example, by enabling the UE 120 to report a CSI report based at least in part on the activated semi-persistent CSI-RS), a delay associated with activating the second SCell 710 may be reduced. For example, a separate message (for example, a separate MAC-CE) may not be transmitted to activate the CSI reporting configuration. Therefore, a delay associated with receiving and processing the separate message (for example, the separate MAC-CE) may be eliminated. Therefore, the UE 120 may transmit the CSI report to the second SCell 710 earlier in time, thereby reducing latency associated with acquiring CSI for the second SCell 710 and reducing latency associated with activating the second SCell 710.

As described above, in some aspects, the SCell activation command (or a MAC-CE that includes or is associated with the SCell activation command) may indicate a TCI state associated with the second SCell 710 and the semi-persistent CSI-RS resource set. For example, the SCell activation command (or a MAC-CE that includes or is associated with the SCell activation command) may indicate that the semi-persistent CSI-RS resource set is a source reference signal for a TCI state. As described above, the TCI state may be a unified TCI state, such that the TCI state may provide beam information (for example, QCL information) for more than one channel. Therefore, the UE 120 and the second SCell 710 may use the semi-persistent CSI-RS to obtain beam information (for example QCL information) for one or more channels between the UE 120 and the second SCell 710. Therefore, based at least in part on transmitting the semi-persistent CSI-RS (and the corresponding CSI report), the second SCell 710 may be activated for the UE 120. The semi-persistent CSI-RS transmitted by the second SCell 710 may be used as a source reference signal for providing QCL information for downlink transmissions on the second SCell 710 or for providing a spatial parameter (for example, a spatial transmit filter) for uplink transmissions on the second SCell 710.

For example, as shown in FIG. 7, the second SCell 710 may use the semi-persistent CSI-RS to obtain QCL information for a PDSCH. For example, the second SCell 710 may use the semi-persistent CSI-RS as a source reference signal to obtain QCL information to enable the second SCell 710 to transmit a PDSCH message (for example, a PDSCH message scheduled by DCI). For example, in a fifth operation 735, the second SCell 710 may transmit, and the UE 120 may receive, a DCI message that schedules a PDSCH message. In a sixth operation 740, the second SCell 710 may transmit, and the UE 120 may receive, the PDSCH message scheduled by the DCI message. As described above, the second SCell 710 may be enabled to transmit the PDSCH message based at least in part on the QCL information (provided by the semi-persistent CSI-RS) for the TCI state associated with the PDSCH. Similarly, the UE 120 may be enabled to receive the PDSCH message based at least in part on the QCL information (provided by the semi-persistent CSI-RS) for the TCI state associated with the PDSCH.

Additionally or alternatively, the UE 120 may transmit, and the second SCell 710 may receive, an uplink transmission, such as a PUSCH message. The UE 120 may transmit the uplink message using a spatial transmit filter that is based at least in part on using the semi-persistent CSI-RS as the source reference signal for the TCI state associated with the uplink channel. For example, the semi-persistent CSI-RS may serve as a source reference signal for a TCI state for the PUSCH between the UE 120 and the second SCell 710. As described above, the TCI state may be a unified TCI state, such that the TCI state provides common beam information for the uplink channel and one or more other channels (such as another uplink channel or a downlink channel).

As a result, latency associated with communications between the UE 120 and the second SCell 710 may be reduced as QCL information for a TCI state (for example, a unified TCI state) for a channel between the UE 120 and the second SCell 710 may be obtained based at least in part on the semi-persistent CSI-RS that is activated by (or with) the SCell activation command. This may reduce latency that would have otherwise been present by using another reference signal (such as an SSB or an aperiodic CSI-RS) as the source reference signal for the TCI state. For example, SSBs may be transmitted less frequently (for example, with a longer periodicity) and may not be capable of providing full QCL information (for example QCL-Type A information) for the TCI state. Moreover, as described above, an aperiodic CSI-RS may be needed (based at least in part on QCL rules or a reference signal rule defined, or otherwise fixed, by a wireless communication standard) to be transmitted after a periodic CSI-RS. Therefore, additional latency associated with waiting for the periodic CSI-RS to be transmitted may be eliminated by using the semi-persistent CSI-RS as the source reference signal for the TCI state.

By activating a semi-persistent CSI-RS resource set with (or by) an SCell activation command, latency associated with activating the second SCell 710 may be reduced, as described above. For example, multiple separate (or independent) MAC-CEs may not be transmitted to active the SCell, to active a TCI state associated with the SCell, and to activate a CSI reporting configuration for the SCell. Therefore, a delay (for example a processing delay) associated with the multiple MAC-CEs may be eliminated by activating a semi-persistent CSI-RS resource set with (or by) an SCell activation command. This enables a direct SCell activation command to reduce the latency associated with activating the SCell while also providing full QCL information for an activated TCI state (for example, by using a semi-persistent CSI-RS rather than another reference signal, such as an SSB) and complying with defined QCL or reference signal rules (for example, by using a semi-persistent CSI-RS rather than an aperiodic CSI-RS).

FIG. 8 is a flowchart illustrating an example process 800 performed, for example, by a UE that supports semi-persistent CSI-RS activation in a direct SCell activation, in accordance with the present disclosure. Example process 800 is an example where the UE (for example, UE 120) performs operations associated with semi-persistent CSI-RS activation in a direct SCell activation.

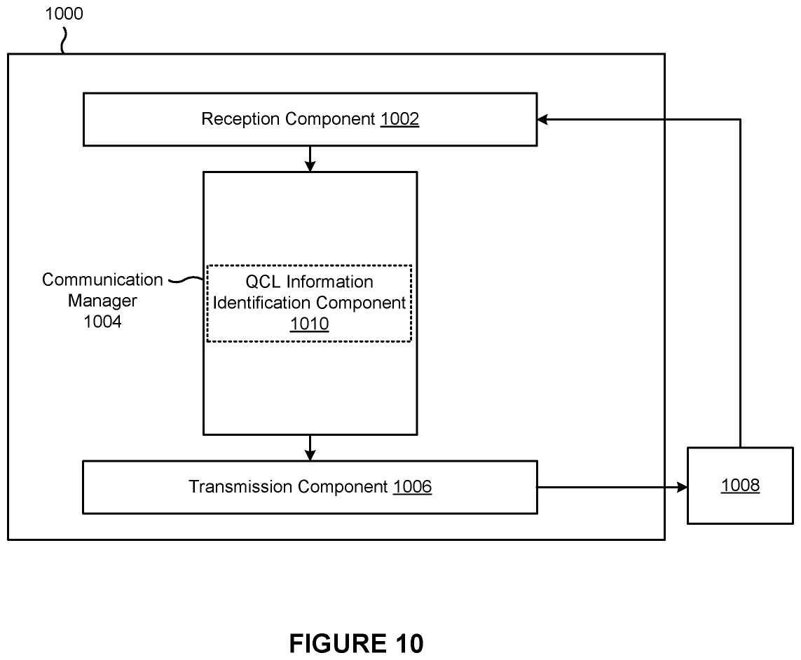

As shown in FIG. 8, in some aspects, process 800 may include receiving a secondary cell activation command that indicates a semi-persistent CSI-RS resource set of a secondary cell (block 810). For example, the UE (such as by using reception component 1002, depicted in FIG. 10) may receive a secondary cell activation command that indicates a semi-persistent CSI-RS resource set of a secondary cell, as described above.

As further shown in FIG. 8, in some aspects, process 800 may include receiving, from the secondary cell, a semi-persistent CSI-RS using the semi-persistent CSI-RS resource set based at least in part on receiving the secondary cell activation command (block 820). For example, the UE (such as by using reception component 1002, depicted in FIG. 10) may receive, from the secondary cell, a semi-persistent CSI-RS using the semi-persistent CSI-RS resource set based at least in part on receiving the secondary cell activation command, as described above.

Process 800 may include additional aspects, such as any single aspect or any combination of aspects described below or in connection with one or more other processes described elsewhere herein.

In a first additional aspect, receiving the secondary cell activation command includes receiving an indication of a CSI reporting configuration, and process 800 includes transmitting, to the secondary cell, a CSI report based at least in part on a measurement of the semi-persistent CSI-RS and the CSI reporting configuration.

In a second additional aspect, alone or in combination with the first aspect, transmitting the CSI report includes transmitting the CSI report for CSI acquisition.

In a third additional aspect, alone or in combination with one or more of the first and second aspects, transmitting the CSI report includes transmitting at least one of a layer 1 RSRP report or a layer 1 SINR report.

In a fourth additional aspect, alone or in combination with one or more of the first through third aspects, receiving the semi-persistent CSI-RS includes receiving at least one of a tracking reference signal, a beam management signal, a CSI acquisition signal, or a positioning reference signal.

In a fifth additional aspect, alone or in combination with one or more of the first through fourth aspects, receiving the secondary cell activation command includes receiving an indication of a TCI state of the secondary cell, and the semi-persistent CSI-RS is a source reference signal for the TCI state of the secondary cell.

In a sixth additional aspect, alone or in combination with one or more of the first through fifth aspects, receiving the secondary cell activation command includes receiving an indication of a TCI state of the secondary cell, where the TCI state is a unified TCI state.

In a seventh additional aspect, alone or in combination with one or more of the first through sixth aspects, receiving the secondary cell activation command includes receiving an indication of a TCI state of the secondary cell that indicates a joint uplink and downlink common TCI state for at least one downlink channel and at least one uplink channel.

In an eighth additional aspect, alone or in combination with one or more of the first through seventh aspects, receiving the secondary cell activation command includes receiving an indication of a TCI state of the secondary cell that indicates a separate downlink common TCI state for at least two downlink channels.

In a ninth additional aspect, alone or in combination with one or more of the first through eighth aspects, receiving the secondary cell activation command includes receiving an indication of a TCI state of the secondary cell that indicates a separate uplink common TCI state for at least two uplink channels.

In a tenth additional aspect, alone or in combination with one or more of the first through ninth aspects, receiving the secondary cell activation command includes receiving an indication of a TCI state of the secondary cell that indicates a single channel TCI state for a downlink channel.

In an eleventh additional aspect, alone or in combination with one or more of the first through tenth aspects, receiving the secondary cell activation command includes receiving an indication of a TCI state of the secondary cell that indicates a single channel TCI state for an uplink channel.

In a twelfth additional aspect, alone or in combination with one or more of the first through eleventh aspects, process 800 includes identifying QCL information for a TCI state of the secondary cell based at least in part on using the semi-persistent CSI-RS as a source reference signal for the TCI state of the secondary cell, and receiving, from the secondary cell, a downlink communication based at least in part on the QCL information.

In a thirteenth additional aspect, alone or in combination with one or more of the first through twelfth aspects, process 800 includes transmitting an uplink communication using a spatial transmit filter that is based at least in part on using the semi-persistent CSI-RS as a source reference signal for a TCI state of the secondary cell of the secondary cell.

In a fourteenth additional aspect, alone or in combination with one or more of the first through thirteenth aspects, receiving the secondary cell activation command comprises receiving a MAC-CE message indicating the secondary cell activation command.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a flowchart illustrating an example process 900 performed, for example, by a base station that supports semi-persistent CSI-RS activation in a direct SCell activation, in accordance with the present disclosure. Example process 900 is an example where the base station (for example, base station 110) performs operations associated with semi-persistent CSI-RS activation in a direct SCell activation.

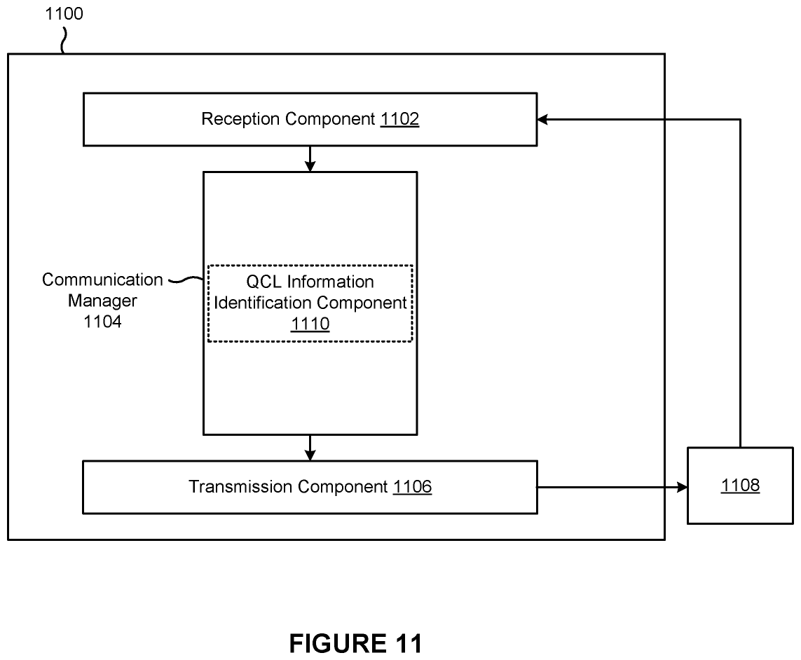

As shown in FIG. 9, in some aspects, process 900 may include transmitting a secondary cell activation command that indicates a semi-persistent CSI-RS resource set of a secondary cell associated with the base station (block 910). For example, the base station (such as by using transmission component 1106, depicted in FIG. 11) may transmit a secondary cell activation command that indicates a semi-persistent CSI-RS resource set of a secondary cell associated with the base station, as described above.

As further shown in FIG. 9, in some aspects, process 900 may include transmitting, to a UE, a semi-persistent CSI-RS using the semi-persistent CSI-RS resource set based at least in part on transmitting the secondary cell activation command (block 920). For example, the base station (such as by using transmission component 1106, depicted in FIG. 11) may transmit, to a UE, a semi-persistent CSI-RS using the semi-persistent CSI-RS resource set based at least in part on transmitting the secondary cell activation command, as described above.

Process 900 may include additional aspects, such as any single aspect or any combination of aspects described below or in connection with one or more other processes described elsewhere herein.

In a first additional aspect, transmitting the secondary cell activation command includes transmitting an indication of a CSI reporting configuration, and process 900 includes receiving, from the UE based at least in part on the CSI reporting configuration, a CSI report indicating a measurement of the semi-persistent CSI-RS.

In a second additional aspect, alone or in combination with the first aspect, receiving the CSI report includes receiving the CSI report for CSI acquisition.

In a third additional aspect, alone or in combination with one or more of the first and second aspects, receiving the CSI report includes receiving at least one of a layer 1 RSRP report or a layer 1 SINR report.

In a fourth additional aspect, alone or in combination with one or more of the first through third aspects, transmitting the semi-persistent CSI-RS includes transmitting at least one of a tracking reference signal, a beam management signal, a CSI acquisition signal, or a positioning reference signal.

In a fifth additional aspect, alone or in combination with one or more of the first through fourth aspects, transmitting the secondary cell activation command includes transmitting an indication of a TCI state of the secondary cell, and the semi-persistent CSI-RS is a source reference signal for the TCI state of the secondary cell.

In a sixth additional aspect, alone or in combination with one or more of the first through fifth aspects, transmitting the secondary cell activation command includes transmitting an indication of a TCI state of the secondary cell, where the TCI state is a unified TCI state.

In a seventh additional aspect, alone or in combination with one or more of the first through sixth aspects, transmitting the secondary cell activation command includes transmitting an indication of a TCI state of the secondary cell that indicates a joint uplink and downlink common TCI state for at least one downlink channel and at least one uplink channel.

In an eighth additional aspect, alone or in combination with one or more of the first through seventh aspects, transmitting the secondary cell activation command includes transmitting an indication of a TCI state of the secondary cell that indicates a separate downlink common TCI state for at least two downlink channels.

In a ninth additional aspect, alone or in combination with one or more of the first through eighth aspects, transmitting the secondary cell activation command includes transmitting an indication of a TCI state of the secondary cell that indicates a separate uplink common TCI state for at least two uplink channels.

In a tenth additional aspect, alone or in combination with one or more of the first through ninth aspects, transmitting the secondary cell activation command includes transmitting an indication of a TCI state of the secondary cell that indicates a single channel TCI state for a downlink channel.

In an eleventh additional aspect, alone or in combination with one or more of the first through tenth aspects, transmitting the secondary cell activation command includes transmitting an indication of a TCI state of the secondary cell that indicates a single channel TCI state for an uplink channel.

In a twelfth additional aspect, alone or in combination with one or more of the first through eleventh aspects, process 900 includes identifying QCL information for a TCI state of the secondary cell based at least in part on using the semi-persistent CSI-RS as a source reference signal for the TCI state of the secondary cell, and transmitting, to the UE, a downlink communication based at least in part on the QCL information.

In a thirteenth additional aspect, alone or in combination with one or more of the first through twelfth aspects, process 900 includes receiving, from the UE, an uplink communication that is transmitted using a spatial transmit filter that is based at least in part on using the semi-persistent CSI-RS as a source reference signal for a TCI state of the secondary cell of the secondary cell.

In a fourteenth additional aspect, alone or in combination with one or more of the first through thirteenth aspects, transmitting the secondary cell activation command includes transmitting a MAC-CE message indicating the secondary cell activation command.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a block diagram of an example apparatus 1000 for wireless communication in accordance with the present disclosure. The apparatus 1000 may be a UE, or a UE may include the apparatus 1000. In some aspects, the apparatus 1000 includes a reception component 1002, a communication manager 1004, and a transmission component 1006, which may be in communication with one another (for example, via one or more buses). As shown, the apparatus 1000 may communicate with another apparatus 1008 (such as a UE, a base station, or another wireless communication device) using the reception component 1002 and the transmission component 1006.

In some aspects, the apparatus 1000 may be configured to perform one or more operations described herein in connection with FIG. 7. Additionally or alternatively, the apparatus 1000 may be configured to perform one or more processes described herein, such as process 800 of FIG. 8, or a combination thereof. In some aspects, the apparatus 1000 may include one or more components of the UE described above in connection with FIG. 2.

The reception component 1002 may receive communications, such as reference signals, control information, data communications, or a combination thereof, from the apparatus 1008. The reception component 1002 may provide received communications to one or more other components of the apparatus 1000, such as the communication manager 1004. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1002 may include one or more antennas, a demodulator, a MIMO detector, a receive processor, a controller/processor, a memory, or a combination thereof, of the UE described above in connection with FIG. 2.

The transmission component 1006 may transmit communications, such as reference signals, control information, data communications, or a combination thereof, to the apparatus 1008. In some aspects, the communication manager 1004 may generate communications and may transmit the generated communications to the transmission component 1006 for transmission to the apparatus 1008. In some aspects, the transmission component 1006 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1006 may include one or more antennas, a modulator, a transmit MIMO processor, a transmit processor, a controller/processor, a memory, or a combination thereof, of the UE described above in connection with FIG. 2. In some aspects, the transmission component 1006 may be co-located with the reception component 1002 in a transceiver.

The communication manager 1004 may receive or may cause the reception component 1002 to receive a secondary cell (SCell) activation command that indicates a semi-persistent CSI-RS resource set of a secondary cell. The communication manager 1004 may receive or may cause the reception component 1002 to receive, from the secondary cell, a semi-persistent CSI-RS using the semi-persistent CSI-RS resource set based at least in part on receiving the secondary cell activation command. In some aspects, the communication manager 1004 may perform one or more operations described elsewhere herein as being performed by one or more components of the communication manager 1004.

The communication manager 1004 may include a controller/processor, a memory, or a combination thereof, of the UE described above in connection with FIG. 2. In some aspects, the communication manager 1004 includes a set of components, such as a QCL information identification component 1010, or a combination thereof. Alternatively, the set of components may be separate and distinct from the communication manager 1004. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive a secondary cell activation command that indicates a semi-persistent CSI-RS resource set of a secondary cell. The reception component 1002 may receive, from the secondary cell, a semi-persistent CSI-RS using the semi-persistent CSI-RS resource set based at least in part on receiving the secondary cell activation command.

The reception component 1002 may receive an indication of a CSI reporting configuration. The transmission component 1006 may transmit, to the secondary cell, a CSI report based at least in part on a measurement of the semi-persistent CSI-RS and the CSI reporting configuration. The transmission component 1006 may transmit the CSI report for CSI acquisition. The transmission component 1006 may transmit at least one of a layer 1 RSRP report or a layer 1 SINR report.

The reception component 1002 may receive an indication of a TCI state of the secondary cell, where the semi-persistent CSI-RS is a source reference signal for the TCI state of the secondary cell. The reception component 1002 may receive an indication of a TCI state of the secondary cell, where the TCI state is a unified TCI state.

The QCL information identification component 1010 may identify QCL information for a TCI state of the secondary cell based at least in part on using the semi-persistent CSI-RS as a source reference signal for the TCI state of the secondary cell. The reception component 1002 may receive, from the secondary cell, a downlink communication based at least in part on the QCL information.

The transmission component 1006 may transmit an uplink communication using a spatial transmit filter that is based at least in part on using the semi-persistent CSI-RS as a source reference signal for a TCI state of the secondary cell of the secondary cell.

The reception component 1002 may receive a MAC-CE message indicating the secondary cell activation command.

The quantity and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

FIG. 11 is a block diagram of an example apparatus 1100 for wireless communication in accordance with the present disclosure. The apparatus 1100 may be a base station, or a base station may include the apparatus 1100. In some aspects, the apparatus 1100 includes a reception component 1102, a communication manager 1104, and a transmission component 1106, which may be in communication with one another (for example, via one or more buses). As shown, the apparatus 1100 may communicate with another apparatus 1108 (such as a UE, a base station, or another wireless communication device) using the reception component 1102 and the transmission component 1106.

In some aspects, the apparatus 1100 may be configured to perform one or more operations described herein in connection with FIG. 7. Additionally or alternatively, the apparatus 1100 may be configured to perform one or more processes described herein, such as process 900 of FIG. 9, or a combination thereof. In some aspects, the apparatus 1100 may include one or more components of the base station described above in connection with FIG. 2.

The reception component 1102 may receive communications, such as reference signals, control information, data communications, or a combination thereof, from the apparatus 1108. The reception component 1102 may provide received communications to one or more other components of the apparatus 1100, such as the communication manager 1104. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1102 may include one or more antennas, a demodulator, a MIMO detector, a receive processor, a controller/processor, a memory, or a combination thereof, of the base station described above in connection with FIG. 2.

The transmission component 1106 may transmit communications, such as reference signals, control information, data communications, or a combination thereof, to the apparatus 1108. In some aspects, the communication manager 1104 may generate communications and may transmit the generated communications to the transmission component 1106 for transmission to the apparatus 1108. In some aspects, the transmission component 1106 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1106 may include one or more antennas, a modulator, a transmit MIMO processor, a transmit processor, a controller/processor, a memory, or a combination thereof, of the base station described above in connection with FIG. 2. In some aspects, the transmission component 1106 may be co-located with the reception component 1102 in a transceiver.

The communication manager 1104 may transmit or may cause the transmission component 1106 to transmit a secondary cell activation command that indicates a semi-persistent CSI-RS resource set of a secondary cell associated with the base station. The communication manager 1104 may transmit or may cause the transmission component 1106 to transmit, to a UE, a semi-persistent CSI-RS using the semi-persistent CSI-RS resource set based at least in part on transmitting the secondary cell activation command. In some aspects, the communication manager 1104 may perform one or more operations described elsewhere herein as being performed by one or more components of the communication manager 1104.

The communication manager 1104 may include a controller/processor, a memory, a scheduler, a communication unit, or a combination thereof, of the base station described above in connection with FIG. 2. In some aspects, the communication manager 1104 includes a set of components, such as a QCL information identification component 1110, or a combination thereof. Alternatively, the set of components may be separate and distinct from the communication manager 1104. In some aspects, one or more components of the set of components may include or may be implemented within a controller/processor, a memory, a scheduler, a communication unit, or a combination thereof, of the base station described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1106 may transmit a secondary cell activation command that indicates a semi-persistent CSI-RS resource set of a secondary cell associated with the base station. The transmission component 1106 may transmit, to a UE, a semi-persistent CSI-RS using the semi-persistent CSI-RS resource set based at least in part on transmitting the secondary cell activation command.

The transmission component 1106 may transmit an indication of a CSI reporting configuration associated with the SCell activation command. The reception component 1102 may receive, from the UE based at least in part on the CSI reporting configuration, a CSI report indicating a measurement of the semi-persistent CSI-RS. The reception component 1102 may receive the CSI report for CSI acquisition.

The transmission component 1106 may transmit an indication of a TCI state of the secondary cell, where the semi-persistent CSI-RS is a source reference signal for the TCI state of the secondary cell. The transmission component 1106 may transmit an indication of a TCI state of the secondary cell, where the TCI state is a unified TCI state.

The QCL information identification component 1110 may identify QCL information for a TCI state of the secondary cell based at least in part on using the semi-persistent CSI-RS as a source reference signal for the TCI state of the secondary cell. The transmission component 1106 may transmit, to the UE, a downlink communication based at least in part on the QCL information.

The reception component 1102 may receive, from the UE, an uplink communication that is transmitted using a spatial transmit filter that is based at least in part on using the semi-persistent CSI-RS as a source reference signal for a TCI state of the secondary cell of the secondary cell.

The transmission component 1106 may transmit a MAC-CE message indicating the secondary cell activation command.

The quantity and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving a secondary cell activation command that indicates a semi-persistent channel state information (CSI) reference signal (CSI-RS) resource set of a secondary cell; and receiving, from the secondary cell, a semi-persistent CSI-RS using the semi-persistent CSI-RS resource set based at least in part on receiving the secondary cell activation command.

Aspect 2: The method of Aspect 1, wherein receiving the secondary cell activation command comprises receiving an indication of a CSI reporting configuration; and the method further comprises transmitting, to the secondary cell, a CSI report based at least in part on a measurement of the semi-persistent CSI-RS and the CSI reporting configuration.

Aspect 3: The method of Aspect 2, wherein transmitting the CSI report comprises transmitting the CSI report for CSI acquisition.

Aspect 4: The method of any of Aspects 2-3, wherein transmitting the CSI report comprises transmitting at least one of a layer 1 reference signal received power (RSRP) report or a layer 1 signal-to-interference-plus-noise ratio (SINR) report.

Aspect 5: The method of any of Aspects 1-4, wherein receiving the semi-persistent CSI-RS comprises receiving at least one of a tracking reference signal, a beam management signal, a CSI acquisition signal, or a positioning reference signal.

Aspect 6: The method of any of Aspects 1-5, wherein receiving the secondary cell activation command comprises receiving an indication of a transmission configuration indicator (TCI) state of the secondary cell, and wherein the semi-persistent CSI-RS is a source reference signal for the TCI state of the secondary cell.

Aspect 7: The method of any of Aspects 1-6, wherein receiving the secondary cell activation command comprises receiving an indication of a transmission configuration indicator (TCI) state of the secondary cell, wherein the TCI state is a unified TCI state.

Aspect 8: The method any of Aspects 1-7, wherein receiving the secondary cell activation command comprises receiving an indication of a transmission configuration indicator (TCI) state of the secondary cell that indicates a joint uplink and downlink common TCI state for at least one downlink channel and at least one uplink channel.

Aspect 9: The method of any of Aspects 1-7, wherein receiving the secondary cell activation command comprises receiving an indication of a transmission configuration indicator (TCI) state of the secondary cell that indicates a separate downlink common TCI state for at least two downlink channels.

Aspect 10: The method of any of Aspects 1-7, wherein receiving the secondary cell activation command comprises receiving an indication of a transmission configuration indicator (TCI) state of the secondary cell that indicates a separate uplink common TCI state for at least two uplink channels.

Aspect 11: The method of any of Aspects 1-7, wherein receiving the secondary cell activation command comprises receiving an indication of a transmission configuration indicator (TCI) state of the secondary cell that indicates a single channel TCI state for a downlink channel.

Aspect 12: The method of any of Aspects 1-7, wherein receiving the secondary cell activation command comprises receiving an indication of a transmission configuration indicator (TCI) state of the secondary cell that indicates a single channel TCI state for an uplink channel.

Aspect 13: The method of any of Aspects 1-12, further comprising: identifying quasi-co-location (QCL) information for a transmission configuration indicator (TCI) state of the secondary cell based at least in part on using the semi-persistent CSI-RS as a source reference signal for the TCI state of the secondary cell; and receiving, from the secondary cell, a downlink communication based at least in part on the QCL information.

Aspect 14: The method of any of Aspects 1-13, further comprising transmitting an uplink communication using a spatial transmit filter that is based at least in part on using the semi-persistent CSI-RS as a source reference signal for a transmission configuration indicator (TCI) state of the secondary cell of the secondary cell.

Aspect 15: The method of any of Aspects 1-14, wherein receiving the secondary cell activation command comprises receiving a medium access control (MAC) control element (MAC-CE) message indicating the secondary cell activation command.

Aspect 16: The method of any of Aspects 1-15, wherein receiving the secondary cell activation command comprises receiving an indication of a transmission configuration indicator (TCI) state of the secondary cell that indicates at least one of: a joint uplink and downlink common TCI state for at least one downlink channel and at least one uplink channel, a separate downlink common TCI state for at least two downlink channels, a separate uplink common TCI state for at least two uplink channels, a single channel TCI state for a downlink channel, or a single channel TCI state for an uplink channel.

Aspect 17: A method of wireless communication performed by a base station, comprising: transmitting a secondary cell activation command that indicates a semi-persistent channel state information (CSI) reference signal (CSI-RS) resource set of a secondary cell associated with the base station; and transmitting, to a user equipment (UE), a semi-persistent CSI-RS using the semi-persistent CSI-RS resource set based at least in part on transmitting the secondary cell activation command.

Aspect 18: The method of Aspect 17, wherein transmitting the secondary cell activation command comprises transmitting an indication of a CSI reporting configuration; and the method further comprises receiving, from the UE based at least in part on the CSI reporting configuration, a CSI report indicating a measurement of the semi-persistent CSI-RS.

Aspect 19: The method of Aspect 18, wherein receiving the CSI report comprises receiving the CSI report for CSI acquisition.

Aspect 20: The method of any of Aspects 18-19, wherein receiving the CSI report comprises receiving at least one of a layer 1 reference signal received power (RSRP) report or a layer 1 signal-to-interference-plus-noise ratio (SINR) report.

Aspect 21: The method of any of Aspects 17-20, wherein transmitting the semi-persistent CSI-RS comprises transmitting at least one of a tracking reference signal, a beam management signal, a CSI acquisition signal, or a positioning reference signal.

Aspect 22: The method of any of Aspects 17-21, wherein transmitting the secondary cell activation command comprises transmitting an indication of a transmission configuration indicator (TCI) state of the secondary cell, and wherein the semi-persistent CSI-RS is a source reference signal for the TCI state of the secondary cell.

Aspect 23: The method of any of Aspects 17-22, wherein transmitting the secondary cell activation command comprises transmitting an indication of a transmission configuration indicator (TCI) state of the secondary cell, wherein the TCI state is a unified TCI state.

Aspect 24: The method of any of Aspects 17-23, wherein transmitting the secondary cell activation command comprises transmitting an indication of a transmission configuration indicator (TCI) state of the secondary cell that indicates a joint uplink and downlink common TCI state for at least one downlink channel and at least one uplink channel.

Aspect 25: The method of any of Aspects 17-23, wherein transmitting the secondary cell activation command comprises transmitting an indication of a transmission configuration indicator (TCI) state of the secondary cell that indicates a separate downlink common TCI state for at least two downlink channels.

Aspect 26: The method of any of Aspects 17-23, wherein transmitting the secondary cell activation command comprises transmitting an indication of a transmission configuration indicator (TCI) state of the secondary cell that indicates a separate uplink common TCI state for at least two uplink channels.

Aspect 27: The method of any of Aspects 17-23, wherein transmitting the secondary cell activation command comprises transmitting an indication of a transmission configuration indicator (TCI) state of the secondary cell that indicates a single channel TCI state for a downlink channel.

Aspect 28: The method of any of Aspects 17-23, wherein transmitting the secondary cell activation command comprises transmitting an indication of a transmission configuration indicator (TCI) state of the secondary cell that indicates a single channel TCI state for an uplink channel.

Aspect 29: The method of any of Aspects 17-28, further comprising: identifying quasi-co-location (QCL) information for a transmission configuration indicator (TCI) state of the secondary cell based at least in part on using the semi-persistent CSI-RS as a source reference signal for the TCI state of the secondary cell; and transmitting, to the UE, a downlink communication based at least in part on the QCL information.

Aspect 30: The method of any of Aspects 17-29, further comprising receiving, from the UE, an uplink communication that is transmitted using a spatial transmit filter that is based at least in part on using the semi-persistent CSI-RS as a source reference signal for a transmission configuration indicator (TCI) state of the secondary cell of the secondary cell.

Aspect 31: The method of any of Aspects 17-30, wherein transmitting the secondary cell activation command comprises transmitting a medium access control (MAC) control element (MAC-CE) message indicating the secondary cell activation command.

Aspect 32: The method of any of Aspects 17-31, wherein transmitting the secondary cell activation command comprises transmitting an indication of a transmission configuration indicator (TCI) state of the secondary cell that indicates at least one of: a joint uplink and downlink common TCI state for at least one downlink channel and at least one uplink channel, a separate downlink common TCI state for at least two downlink channels, a separate uplink common TCI state for at least two uplink channels, a single channel TCI state for a downlink channel, or a single channel TCI state for an uplink channel.

Aspect 31: An apparatus for wireless communication at a device, comprising a processor; memory coupled with the processor; and instructions stored in the memory and executable by the processor to cause the apparatus to perform the method of one or more Aspects of Aspects 1-16.

Aspect 32: A device for wireless communication, comprising a memory and one or more processors coupled to the memory, the memory and the one or more processors configured to perform the method of one or more Aspects of Aspects 1-16.

Aspect 33: An apparatus for wireless communication, comprising at least one means for performing the method of one or more Aspects of Aspects 1-16.

Aspect 34: A non-transitory computer-readable medium storing code for wireless communication, the code comprising instructions executable by a processor to perform the method of one or more Aspects of Aspects 1-16.

Aspect 35: A non-transitory computer-readable medium storing a set of instructions for wireless communication, the set of instructions comprising one or more instructions that, when executed by one or more processors of a device, cause the device to perform the method of one or more Aspects of Aspects 1-16.

Aspect 36: An apparatus for wireless communication at a device, comprising a processor; memory coupled with the processor; and instructions stored in the memory and executable by the processor to cause the apparatus to perform the method of one or more Aspects of Aspects 17-32.

Aspect 37: A device for wireless communication, comprising a memory and one or more processors coupled to the memory, the memory and the one or more processors configured to perform the method of one or more Aspects of Aspects 17-32.

Aspect 38: An apparatus for wireless communication, comprising at least one means for performing the method of one or more Aspects of Aspects 17-32.

Aspect 39: A non-transitory computer-readable medium storing code for wireless communication, the code comprising instructions executable by a processor to perform the method of one or more Aspects of Aspects 17-32.

Aspect 40: A non-transitory computer-readable medium storing a set of instructions for wireless communication, the set of instructions comprising one or more instructions that, when executed by one or more processors of a device, cause the device to perform the method of one or more Aspects of Aspects 17-32.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. It will be apparent that systems or methods described herein may be implemented in different forms of hardware, firmware, or a combination of hardware and software. The actual specialized control hardware or software code used to implement these systems or methods is not limiting of the aspects. Thus, the operation and behavior of the systems or methods were described herein without reference to specific software code—it being understood that software and hardware can be designed to implement the systems or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. In fact, many of these features may be combined in ways not specifically recited in the claims or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one processor; and
at least one memory communicatively coupled with the at least one processor and storing processor-readable code that, when executed by the at least one processor, is configured to cause the UE to:
receive a secondary cell activation command that indicates a semi-persistent channel state information (CSI) reference signal (CSI-RS) resource set of a secondary cell; and
receive, from the secondary cell, a semi-persistent CSI-RS using the semi-persistent CSI-RS resource set based at least in part on receiving the secondary cell activation command.

2. The UE of claim 1, wherein:
the processor-readable code, when executed by the at least one processor to receive the secondary cell activation command, is configured to cause the UE to receive an indication of a CSI reporting configuration; and
the processor-readable code, when executed by the at least one processor, is further configured to cause the UE to transmit, to the secondary cell, a CSI report based at least in part on a measurement of the semi-persistent CSI-RS and the CSI reporting configuration.

3. The UE of claim 2, wherein the processor-readable code, when executed by the at least one processor to transmit the CSI report, is configured to cause the UE to transmit at least one of the CSI report for CSI acquisition, a layer 1 reference signal received power (RSRP) report, or a layer 1 signal-to-interference-plus-noise ratio (SINR) report.

4. The UE of claim 1, wherein the processor-readable code, when executed by the at least one processor to receive the semi-persistent CSI-RS, is configured to cause the UE to receive at least one of a tracking reference signal, a beam management signal, a CSI acquisition signal, or a positioning reference signal.

5. The UE of claim 1, wherein the processor-readable code, when executed by the at least one processor to receive the secondary cell activation command, is configured to cause the UE to receive an indication of a transmission configuration indicator (TCI) state of the secondary cell, and wherein the semi-persistent CSI-RS is a source reference signal for the TCI state of the secondary cell.

6. The UE of claim 1, wherein the processor-readable code, when executed by the at least one processor to receive the secondary cell activation command, is configured to cause the UE to receive an indication of a transmission configuration indicator (TCI) state of the secondary cell, wherein the TCI state is a unified TCI state.

7. The UE of claim 1, wherein the processor-readable code, when executed by the at least one processor to receive the secondary cell activation command, is configured to cause the UE to receive an indication of a transmission configuration indicator (TCI) state of the secondary cell that indicates at least one of:
a joint uplink and downlink common TCI state for at least one downlink channel and at least one uplink channel,
a separate downlink common TCI state for at least two downlink channels,
a separate uplink common TCI state for at least two uplink channels,
a single channel TCI state for a downlink channel, or
a single channel TCI state for an uplink channel.

8. The UE of claim 1, wherein the processor-readable code, when executed by the at least one processor, is further configured to cause the UE to:
identify quasi-colocation (QCL) information for a transmission configuration indicator (TCI) state of the secondary cell based at least in part on using the semi-persistent CSI-RS as a source reference signal for the TCI state of the secondary cell; and
receive, from the secondary cell, a downlink communication based at least in part on the QCL information.

9. The UE of claim 1, wherein the processor-readable code, when executed by the at least one processor, is further configured to cause the UE to transmit an uplink communication using a spatial transmit filter that is based at least in part on using the semi-persistent CSI-RS as a source reference signal for a transmission configuration indicator (TCI) state of the secondary cell of the secondary cell.

10. The UE of claim 1, wherein the processor-readable code, when executed by the at least one processor to receive the secondary cell activation command, is configured to cause the UE to receive a medium access control (MAC) control element (MAC-CE) message indicating the secondary cell activation command.

11. A base station for wireless communication, comprising:
at least one processor; and
at least one memory communicatively coupled with the at least one processor and storing processor-readable code that, when executed by the at least one processor, is configured to cause the base station to:
transmit a secondary cell activation command that indicates a semi-persistent channel state information (CSI) reference signal (CSI-RS) resource set of a secondary cell associated with the base station; and
transmit, to a user equipment (UE), a semi-persistent CSI-RS using the semi-persistent CSI-RS resource set based at least in part on transmitting the secondary cell activation command.

12. The base station of claim 11, wherein the processor-readable code, when executed by the at least one processor to transmit the secondary cell activation command, is configured to cause the base station to transmit an indication of a CSI reporting configuration; and the processor-readable code, when executed by the at least one processor, is further configured to cause the base station to receive, from the UE based at least in part on the CSI reporting configuration, a CSI report indicating a measurement of the semi-persistent CSI-RS.

13. The base station of claim 12, wherein the processor-readable code, when executed by the at least one processor to receive the CSI report, is configured to cause the base station to receive at least one of the CSI report for CSI acquisition, a layer 1 reference signal received power (RSRP) report, or a layer 1 signal-to-interference-plus-noise ratio (SINR) report.

14. The base station of claim 11, wherein the processor-readable code, when executed by the at least one processor to transmit the semi-persistent CSI-RS, is configured to cause the base station to transmit at least one of a tracking reference signal, a beam management signal, a CSI acquisition signal, or a positioning reference signal.

15. The base station of claim 11, wherein the processor-readable code, when executed by the at least one processor to transmit the secondary cell activation command, is configured to cause the base station to transmit an indication of a transmission configuration indicator (TCI) state of the secondary cell, and wherein the semi-persistent CSI-RS is a source reference signal for the TCI state of the secondary cell.

16. The base station of claim 11, wherein the processor-readable code, when executed by the at least one processor to transmit the secondary cell activation command, is configured to cause the base station to transmit an indication of a transmission configuration indicator (TCI) state of the secondary cell, wherein the TCI state is a unified TCI state.

17. The base station of claim 11, wherein the processor-readable code, when executed by the at least one processor to transmit the secondary cell activation command, is configured to cause the base station to transmit an indication of a transmission configuration indicator (TCI) state of the secondary cell that indicates at least one of:
a joint uplink and downlink common TCI state for at least one downlink channel and at least one uplink channel,
a separate downlink common TCI state for at least two downlink channels,
a separate uplink common TCI state for at least two uplink channels,
a single channel TCI state for a downlink channel, or
a single channel TCI state for an uplink channel.

18. The base station of claim 11, wherein the processor-readable code, when executed by the at least one processor, is further configured to cause the base station to:
identify quasi-colocation (QCL) information for a transmission configuration indicator (TCI) state of the secondary cell based at least in part on using the semi-persistent CSI-RS as a source reference signal for the TCI state of the secondary cell; and
transmit, to the UE, a downlink communication based at least in part on the QCL information.

19. The base station of claim 11, wherein the processor-readable code, when executed by the at least one processor, is further configured to cause the base station to receive, from the UE, an uplink communication that is transmitted using a spatial transmit filter that is based at least in part on using the semi-persistent CSI-RS as a source reference signal for a transmission configuration indicator (TCI) state of the secondary cell of the secondary cell.

20. The base station of claim 11, wherein the processor-readable code, when executed by the at least one processor to transmit the secondary cell activation command, is configured to cause the base station to transmit a medium access control (MAC) control element (MAC-CE) message indicating the secondary cell activation command.

21. A method of wireless communication performed by a user equipment (UE), comprising:
receiving a secondary cell activation command that indicates a semi-persistent channel state information (CSI) reference signal (CSI-RS) resource set of a secondary cell; and
receiving, from the secondary cell, a semi-persistent CSI-RS using the semi-persistent CSI-RS resource set based at least in part on receiving the secondary cell activation command.

22. The method of claim 21, wherein receiving the secondary cell activation command comprises receiving an indication of a CSI reporting configuration; and the method further comprises transmitting, to the secondary cell, a CSI report based at least in part on a measurement of the semi-persistent CSI-RS and the CSI reporting configuration.

23. The method of claim 21, wherein receiving the semi-persistent CSI-RS comprises receiving at least one of a tracking reference signal, a beam management signal, a CSI acquisition signal, or a positioning reference signal.

24. The method of claim 21, wherein receiving the secondary cell activation command comprises receiving an indication of a transmission configuration indicator (TCI) state of the secondary cell, and wherein the semi-persistent CSI-RS is a source reference signal for the TCI state of the secondary cell.

25. The method of claim 21, wherein receiving the secondary cell activation command comprises receiving an indication of a transmission configuration indicator (TCI) state of the secondary cell, wherein the TCI state is a unified TCI state.

26. The method of claim 21, wherein receiving the secondary cell activation command comprises receiving an indication of a transmission configuration indicator (TCI) state of the secondary cell that indicates at least one of:
a joint uplink and downlink common TCI state for at least one downlink channel and at least one uplink channel,
a separate downlink common TCI state for at least two downlink channels,
a separate uplink common TCI state for at least two uplink channels,
a single channel TCI state for a downlink channel, or
a single channel TCI state for an uplink channel.

27. The method of claim 21, further comprising transmitting an uplink communication using a spatial transmit filter that is based at least in part on using the semi-persistent CSI-RS as a source reference signal for a transmission configuration indicator (TCI) state of the secondary cell of the secondary cell.

28. The method of claim 21, wherein receiving the secondary cell activation command comprises receiving a medium access control (MAC) control element (MAC-CE) message indicating the secondary cell activation command.

29. A method of wireless communication performed by a base station, comprising:
transmitting a secondary cell activation command that indicates a semi-persistent channel state information (CSI) reference signal (CSI-RS) resource set of a secondary cell associated with the base station; and
transmitting, to a user equipment (UE), a semi-persistent CSI-RS using the semi-persistent CSI-RS resource set based at least in part on transmitting the secondary cell activation command.

30. The method of claim 29, wherein transmitting the secondary cell activation command comprises transmitting an indication of a CSI reporting configuration; and the method further comprises receiving, from the UE based at least in part on the CSI reporting configuration, a CSI report indicating a measurement of the semi-persistent CSI-RS, wherein the CSI report is associated with at least one of CSI acquisition, a layer 1 reference signal received power (RSRP) report, or a layer 1 signal-to-interference-plus-noise ratio (SINR) report.

31. The method of claim 29, wherein transmitting the secondary cell activation command comprises transmitting an indication of a transmission configuration indicator (TCI) state of the secondary cell, and wherein the semi-persistent CSI-RS is a source reference signal for the TCI state of the secondary cell.

32. The method of claim 29, wherein transmitting the secondary cell activation command comprises transmitting an indication of a transmission configuration indicator (TCI) state of the secondary cell, wherein the TCI state is a unified TCI state.

33. The method of claim 29, further comprising:
identifying quasi-colocation (QCL) information for a transmission configuration indicator (TCI) state of the secondary cell based at least in part on using the semi-persistent CSI-RS as a source reference signal for the TCI state of the secondary cell; and
transmitting, to the UE, a downlink communication based at least in part on the QCL information.

34. The method of claim 29, further comprising receiving, from the UE, an uplink communication that is transmitted using a spatial transmit filter that is based at least in part on using the semi-persistent CSI-RS as a source reference signal for a transmission configuration indicator (TCI) state of the secondary cell of the secondary cell.

35. An apparatus for wireless communication, comprising:
means for receiving a secondary cell activation command that indicates a semi-persistent channel state information (CSI) reference signal (CSI-RS) resource set of a secondary cell; and
means for receiving, from the secondary cell, a semi-persistent CSI-RS using the semi-persistent CSI-RS resource set based at least in part on receiving the secondary cell activation command.
